(19) United States
(12) Patent Application Publication
(10) Pub. No.: US 2017/0046738 A1
(43) Pub. Date: Feb. 16, 2017

(54) System And Method For Providing An E-Vapor Club

(71) Applicant: Lunatech, LLC, Studio City, CA (US)

(72) Inventor: John Cameron, Studio City, CA (US)

(21) Appl. No.: 15/231,189

(22) Filed: Aug. 8, 2016

Related U.S. Application Data
(60) Provisional application No. 62/203,213, filed on Aug. 10, 2015.

(51) Int. Cl. G06Q 30/02; A24F 47/00

(52) U.S. Cl. CPC G06Q 30/0255; A24F 47/008

(57) ABSTRACT

A method is disclosed comprising receiving, by a central server, usage data related to an electronic vapor device, determining, by the central server, a good based on the usage data and a user preference, initiating, by the central server, a transfer of the good to a user of the electronic vapor device, generating, by the central server, an indication that the transfer of the good to the user of the electronic vapor device has initiated, and transmitting, by the central server, the indication to the electronic vapor device.

### CROSS REFERENCE TO RELATED PATENT APPLICATION

This application claims priority to U.S. Provisional Application No. 62/203,213 filed Aug. 10, 2015, here incorporated by reference in its entirety.

### BACKGROUND

Various types of personal vaporizers have been known in the art for many years. In general, such vaporizers are characterized by heating a solid to a smoldering point, vaporizing a liquid by heat, or nebulizing a liquid by heat and/or by expansion through a nozzle. Such devices are designed to release aromatic materials in the solid or liquid while avoiding high temperatures of combustion and associated formation of tars, carbon monoxide, or other harmful byproducts. Many different styles of personal vaporizers, as well as a variety of vaporizable materials for use with personal vaporizers, have been introduced to the marketplace, increasing the competition for providers of personal vaporizers and vaporizable materials. Due to the lucrative nature of the personal vaporizer industry and the wide variety of options, it is desirable for a distributor to be able to target advertisements to specific users.

A counter culture including users of personal vaporizers has been steadily growing with the popularity of these devices. Many stores that sell personal vaporizers and accessories are also being used as meeting places where users can congregate. However, many users prefer the convenience of online purchases due to the relative ease of purchasing and the variety available online. Some of these users still have an interest in the social aspect of personal vaporizers but do not have the time to go to the retail stores.

It would be desirable, therefore, to develop new technologies for providing an online meeting place for users of personal vaporizers to socialize which can also gather information about the users and use that information to generate targeted advertisements and offers.

### SUMMARY

It is to be understood that both the following general description and the following detailed description are exemplary and explanatory only and are not restrictive. In an aspect, a method is disclosed comprising generating, by an electronic vapor device, usage data related to the electronic vapor device, transmitting, by the electronic vapor device, the usage data to a central server, receiving, by the electronic vapor device, an indication that a transfer of a good to a user of the electronic vapor device has initiated based on the usage data and a user preference, and displaying the indication.

In another aspect, a method is disclosed comprising receiving, by a central server, usage data related to an electronic vapor device, determining, by the central server, a good based on the usage data and a user preference, initiating, by the central server, a transfer of the good to a user of the electronic vapor device, generating, by the central server, an indication that the transfer of the good to the user of the electronic vapor device has initiated, and transmitting, by the central server, the indication to the electronic vapor device.

Additional advantages will be set forth in part in the description which follows or can be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The features, nature, and advantages of the present disclosure will become more apparent from the detailed description set forth below when taken in conjunction with the drawings, in which like reference characters are used to identify like elements correspondingly throughout the specification and drawings.

FIG. 1 illustrates a block diagram of an exemplary electronic vapor device;

FIG. 2 illustrates an exemplary vaporizer;

FIG. 3 illustrates an exemplary vaporizer configured for vaporizing a mixture of vaporizable material;

FIG. 4 illustrates an exemplary vaporizer device configured for smooth vapor delivery;

FIG. 5 illustrates another exemplary vaporizer configured for smooth vapor delivery;

FIG. 6 illustrates another exemplary vaporizer configured for smooth vapor delivery;

FIG. 7 illustrates another exemplary vaporizer configured for smooth vapor delivery;

FIG. 8 illustrates an exemplary vaporizer configured for filtering air;

FIG. 9 illustrates an interface of an exemplary electronic vapor device;

FIG. 10 illustrates another interface of an exemplary electronic vapor device;

FIG. 11 illustrates several interfaces of an exemplary electronic vapor device;

FIG. 12 illustrates an exemplary operating environment;

FIG. 13 illustrates another exemplary operating environment;

FIG. 14 is a schematic diagram illustrating aspects of a system for providing an e-vapor club to one or more electronic vaporizer devices;

FIG. 15 is a block diagram of an electronic vapor device for interfacing with the e-vapor club;

FIG. 16 is a schematic diagram of an internal vaporizer device;

FIG. 17 is a schematic diagram of a server for providing the e-vapor club;

FIG. 18 is a block diagram illustrating aspects of an apparatus used to provide the e-vapor club;

FIG. 19 illustrates an exemplary method;

FIG. 20 illustrates an exemplary method;

FIG. 21 illustrates an exemplary method;

FIG. 22 illustrates an exemplary method;

FIG. 23 illustrates an exemplary method;

FIG. 24 illustrates an exemplary method; and

FIG. 25 illustrates an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods, Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium can be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions can be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Various aspects are now described with reference to the drawings. In the following description, for purposes of explanation, numerous specific details are set forth in order to provide a thorough understanding of one or more aspects. It can be evident, however, that the various aspects can be practiced without these specific details. In other instances, well-known structures and devices are shown in block diagram form in order to facilitate describing these aspects.

While embodiments of the disclosure are directed to vaporizing devices, it should be appreciated that aspects of the technology can be adapted by one of ordinary skill to nebulizing devices designed to produce an inhalable mist or aerosol.

The present disclosure relates to a system for providing an e-vapor club accessible by electronic vapor devices and, more particularly, to a system for providing an interface, generating offers and shipping a product in various manners.

In an aspect of the disclosure, a system for managing an e-vapor club includes a server having a network communication device for communicating with at least one electronic vapor device and a processor for providing an e-vapor club service usable by the at least one electronic vapor device.

In another aspect, a method for providing an e-vapor club by a server includes generating, by a processor, an e-vapor club interface and receiving, from a electronic vapor device, data.

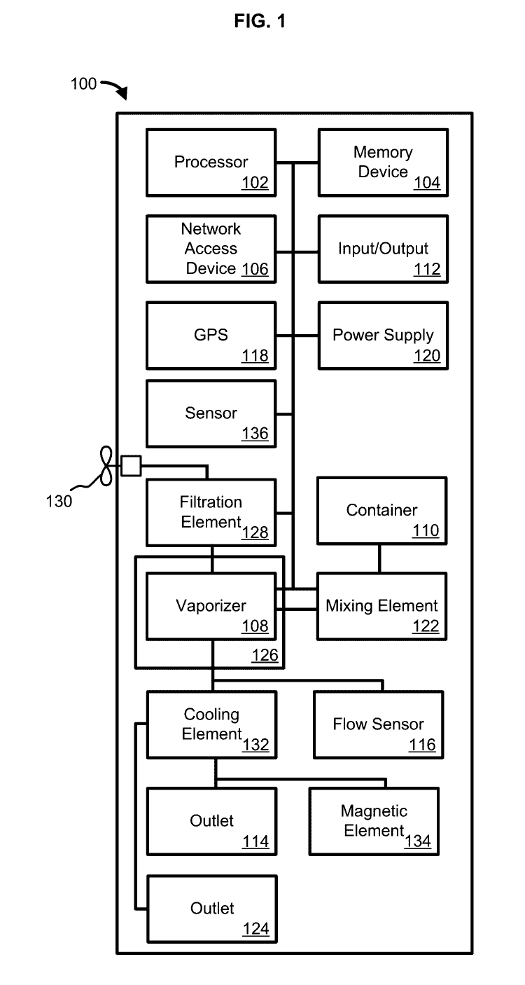

FIG. 1 is a block diagram of an exemplary electronic vapor device 100 as described herein. The electronic vapor device 100 can be, for example, an e-cigarette, an e-cigar, an electronic vapor device, a hybrid electronic communication handset coupled/integrated vapor device, a robotic vapor device, a modified vapor device “mod,” a micro-sized electronic vapor device, a robotic vapor device, and the like. The vapor device 100 can comprise any suitable housing for enclosing and protecting the various components disclosed herein. The vapor device 100 can comprise a processor 102. The processor 102 can be, or can comprise, any suitable microprocessor or microcontroller, for example, a low-power application-specific controller (ASIC) and/or a field programmable gate array (FPGA) designed or programmed specifically for the task of controlling a device as described herein, or a general purpose central processing unit (CPU), for example, one based on 80×86 architecture as designed by Intel™ or AMD™, or a system-on-a-chip as designed by ARM™. The processor 102 can be coupled (e.g., communicatively, operatively, etc . . . ) to auxiliary devices or modules of the vapor device 100 using a bus or other coupling. The vapor device 100 can comprise a power supply 110. The power supply 110 can comprise one or more batteries and/or other power storage device (e.g., capacitor) and/or a port for connecting to an external power supply. For example, an external power supply can supply power to the vapor device 100 and a battery can store at least a portion of the supplied power. The one or more batteries can be rechargeable. The one or more batteries can comprise a lithium-ion battery (including thin film lithium ion batteries), a lithium ion polymer battery, a nickelcadmium battery, a nickel metal hydride battery, a lead-acid battery, combinations thereof, and the like. In an aspect, the power supply 110 can receive power via a power coupling to a case, wherein the vapor device 100 is stored in the case.

The vapor device 100 can comprise a memory device 104 coupled to the processor 102. The memory device 104 can comprise a random access memory (RAM) configured for storing program instructions and data for execution or processing by the processor 102 during control of the vapor device 100. When the vapor device 100 is powered off or in an inactive state, program instructions and data can be stored in a long-term memory, for example, a non-volatile magnetic optical, or electronic memory storage device (not shown). Either or both of the RAM or the long-term memory can comprise a non-transitory computer-readable medium storing program instructions that, when executed by the processor 102, cause the vapor device 100 to perform all or part of one or more methods and/or operations described herein. Program instructions can be written in any suitable high-level language, for example, C, C++, C# or the Java™, and compiled to produce machine-language code for execution by the processor 102.

In an aspect, the vapor device 100 can comprise a network access device 106 allowing the vapor device 100 to be coupled to one or more ancillary devices (not shown) such as via an access point (not shown) of a wireless telephone network, local area network, or other coupling to a wide area network, for example, the Internet. In that regard, the processor 102 can be configured to share data with the one or more ancillary devices via the network access device 106 The shared data can comprise, for example, usage data and/or operational data of the vapor device 100, a status of the vapor device 100, a status and/or operating condition of one or more the components of the vapor device 100, text to be used in a message, a product order, payment information, and/or any other data. Similarly, the processor 102 can be configured to receive control instructions from the one or more ancillary devices via the network access device 106. For example, a configuration of the vapor device 100, an operation of the vapor device 100, and/or other settings of the vapor device 100, can be controlled by the one or more ancillary devices via the network access device 106. For example, an ancillary device can comprise a server that can provide various services and another ancillary device can comprise a smartphone for controlling operation of the vapor device 100. In some aspects, the smartphone or another ancillary device can be used as a primary input/output of the vapor device 100 such that data is received by the vapor device 100 from the server, transmitted to the smartphone, and output on a display of the smartphone. In an aspect, data transmitted to the ancillary device can comprise a mixture of vaporizable material and/or instructions to release vapor. For example, the vapor device 100 can be configured to determine a need for the release of vapor into the atmosphere. The vapor device 100 can provide instructions via the network access device 106 to an ancillary device (e.g., another vapor device) to release vapor into the atmosphere.

In an aspect, data can be shared anonymously. The data can be shared over a transient data session with an ancillary device. The transient data session can comprise a session limit. The session limit can be based on one or more of a number of puffs, a time limit, and a total quantity of vaporizable material. The data can comprise usage data and/or a usage profile.

In an aspect, the vapor device 100 can also comprise an input/output device 112 coupled to one or more of the processor 102, the vaporizer 108, the network access device 106, and/or any other electronic component of the vapor device 100. Input can be received from a user or another device and/or output can be provided to a user or another device via the input/output device 112. The input/output device 112 can comprise any combinations of input and/or output devices such as buttons, knobs, keyboards, touchscreens, displays, light-emitting elements, a speaker, and/or the like. In an aspect, the input/output device 112 can comprise an interface port (not shown) such as a wired interface, for example a serial port, a Universal Serial Bus (USB) port, an Ethernet port, or other suitable wired connection. The input/output device 112 can comprise a wireless interface (not shown), for example a transceiver using any suitable wireless protocol, for example WiFi (IEEE 802.11), Bluetooth®, infrared, or other wireless standard, For example, the input/output device 112 can communicate with a smartphone via Bluetooth® such that the inputs and outputs of the smartphone can be used by the user to interface with the vapor device 100. In an aspect, the input/output device 112 can comprise a user interface. The user interface user interface can comprise at least one of lighted signal lights, gauges, boxes, forms, check marks, avatars, visual images, graphic designs, lists, active calibrations or calculations, 2D interactive fractal designs, 3D fractal designs, 2D and/or 3D representations of vapor devices and other interface system functions. In an aspect, regardless of whether the vapor device 100 comprises a display, the vapor device 100 can communicate with an authorized electronic device to provide a user interface via the authorized electronic device that controls functionality of the vapor device 100.

In an aspect, the input/output device 112 can be coupled to an adaptor device to receive power and/or send/receive data signals from an electronic device. For example, the input/output device 112 can be configured to receive power from the adaptor device and provide the power to the power supply 120 to recharge one or more batteries. The input/output device 112 can exchange data signals received from the adaptor device with the processor 102 to cause the processor to execute one or more functions.

In an aspect, the input/output device 112 can comprise a touchscreen interface and/or a biometric interface. For example, the input/output device 112 can include controls that allow the user to interact with and input information and commands to the vapor device 100. For example, with respect to the embodiments described herein, the input/output device 112 can comprise a touch screen display. The input/output device 112 can be configured to provide the content of the exemplary screen shots shown herein, which are presented to the user via the functionality of a display. User inputs to the touch screen display are processed by, for example, the input/output device 112 and/or the processor 102. The input/output device 112 can also be configured to process new content and communications to the system 100. The touch screen display can provide controls and menu selections, and process commands and requests. Application and content objects can be provided by the touch screen display. The input/output device 112 and/or the processor 102 can receive and interpret commands and other inputs, interface with the other components of the vapor device 100 as required. In an aspect, the touch screen display can enable a user to lock, unlock, or partially unlock or lock, the vapor device 100. The vapor device 100 can be transitioned from an idle and locked state into an open state by, for example, moving or dragging an icon on the screen of the vapor device 100, entering in a password/passcode, and the like. The input/output device 112 can thus display information to a user such as a puff count, an amount of vaporizable material remaining in the container 110, battery remaining, signal strength, combinations thereof, and the like.

In an aspect, the input/output device 112 can comprise an audio user interface. A microphone can be configured to receive audio signals and relay the audio signals to the input/output device 112. The audio user interface can be any interface that is responsive to voice or other audio commands. The audio user interface can be configured to cause an action, activate a function, etc, by the vapor device 100 (or another device) based on a received voice (or other audio) command. The audio user interface can be deployed directly on the vapor device 100 and/or via other electronic devices (e.g., electronic communication devices such as a smartphone, a smart watch, a tablet, a laptop, a dedicated audio user interface device, and the like). The audio user interface can be used to control the functionality of the vapor device 100. Such functionality can comprise, but is not limited to, custom mixing of vaporizable material (e.g., eLiquids) and/or ordering custom made eLiquid combinations via an eCommerce service (e.g., specifications of a user's custom flavor mix can be transmitted to an eCommerce service, so that an eLiquid provider can mix a custom eLiquid cartridge for the user). The user can then reorder the custom flavor mix anytime or even send it to friends as a present, all via the audio user interface, The user can also send via voice command a mixing recipe to other users. The other users can utilize the mixing recipe (e.g., via an electronic vapor device having multiple chambers for eLiquid) to sample the same mix via an auto-order to the other users' devices to create the received mixing recipe. A custom mix can be given a title by a user and/or can be defined by parts e.g., one part liquid A and two parts liquid B). The audio user interface can also be utilized to create and send a custom message to other users, to join eVapor clubs, to receive eVapor chart information, and to conduct a wide range of social networking, location services and eCommerce activities. The audio user interface can be secured via a password (e.g., audio password) which features at least one of tone recognition, other voice quality recognition and, in one aspect, can utilize at least one special cadence as part of the audio password.

The input/output device 112 can be configured to interface with other devices, for example, exercise equipment, computing equipment, communications devices and/or other vapor devices, for example, via a physical or wireless connection. The input/output device 112 can thus exchange data with the other equipment. A user may sync their vapor device 100 to other devices, via programming attributes such as mutual dynamic link library (DLL) ‘hooks’. This enables a smooth exchange of data between devices, as can a web interface between devices. The input/output device 112 can be used to upload one or more profiles to the other devices. Using exercise equipment as an example, the one or more profiles can comprise data such as workout routine data (e.g., timing, distance, settings, heart rate, etc . . . ) and vaping data (e.g., eLiquid mixture recipes, supplements, vaping timing, etc . . . ). Data from usage of previous exercise sessions can be archived and shared with new electronic vapor devices and/or new exercise equipment so that history and preferences may remain continuous and provide for simplified device settings, default settings, and recommended settings based upon the synthesis of current and archival data.

In an aspect, the vapor device 100 can comprise a vaporizer 108. The vaporizer 108 can be coupled to one or more containers 110. Each of the one or more containers 110 can be configured to hold one or more vaporizable or non-vaporizable materials. The vaporizer 108 can receive the one or more vaporizable or non-vaporizable materials from the one or more containers 110 and heat the one or more vaporizable or non-vaporizable materials until the one or more vaporizable or non-vaporizable materials achieve a vapor state. In various embodiments, instead of heating the one or more vaporizable or non-vaporizable materials, the vaporizer 108 can nebulize or otherwise cause the one or more vaporizable or non-vaporizable materials in the one or more containers 110 to reduce in size into particulates. In various embodiments, the one or more containers 110 can comprise a compressed liquid that can be released to the vaporizer 108 via a valve or another mechanism. In various embodiments, the one or more containers 110 can comprise a wick (not shown) through which the one or more vaporizable or non-vaporizable materials is drawn to the vaporizer 108. The one or more containers 110 can be made of any suitable structural material, such as, an organic polymer, metal, ceramic, composite, or glass material. In an aspect, the vaporizable material can comprise one or more of, a Propylene Glycol (PG) based liquid, a Vegetable Glycerin (VG) based liquid, a water based liquid, combinations thereof, and the like. In an aspect, the vaporizable material can comprise Tetrahydrocannabinol (THC), Cannabidiol (CBD), cannabinol (CBN), combinations thereof, and the like. In a further aspect, the vaporizable material can comprise an extract from duboisia hopwoodii.

In an aspect, the vapor device 100 can comprise a mixing element 122. The mixing element 122 can be coupled to the processor 102 to receive one or more control signals. The one or more control signals can instruct the mixing element 122 to withdraw specific amounts of fluid from the one or more containers 110. The mixing element can, in response to a control signal from the processor 102, withdraw select quantities of vaporizable material in order to create a customized mixture of different types of vaporizable material. The liquid withdrawn by the mixing element 122 can be provided to the vaporizer 108.

The vapor device 100 may include a plurality of valves, wherein a respective one of the valves is interposed between the vaporizer 108 and a corresponding one of outlet 114 and/or outlet 124 (e.g., one or more inlets of flexible tubes). Each of the valves may control a flow rate through a respective one of the flexible tubes. For example, each of the plurality of valves may include a lumen of adjustable effective diameter for controlling a rate of vapor flow there through. The assembly may include an actuator, for example a motor, configured to independently adjust respective ones of the valves under control of the processor. The actuator may include a handle or the like to permit manual valve adjustment by the user. The motor or actuator can be coupled to a uniform flange or rotating spindle coupled to the valves and configured for controlling the flow of vapor through each of the valves. Each of the valves can be adjusted so that each of the flexible tubes accommodate the same (equal) rate of vapor flow, or different rates of flow. The processor 102 can be configured to determine settings for the respective ones of the valves each based on at least one of: a selected user preference or an amount of suction applied to a corresponding one of the flexible tubes. A user preference can be determined by the processor 102 based on a user input, which can be electrical or mechanical. An electrical input can be provided, for example, by a touchscreen, keypad, switch, or potentiometer (e.g., the input/output 112). A mechanical input can be provided, for example, by applying suction to a mouthpiece of a tube, turning a valve handle, or moving a gate piece.

The vapor device 100 may further include at least one light-emitting element positioned on or near each of the outlet 114 and/or the outlet 124 (e.g., flexible tubes) and configured to illuminate in response to suction applied to the outlet 114 and/or the outlet 124. At least one of an intensity of illumination or a pattern of alternating between an illuminated state and a non-illuminated state can be adjusted based on an amount of suction. One or more of the at least one light-emitting element, or another light-emitting element, may illuminate based on an amount of vaporizable material available. For example, at least one of an intensity of illumination or a pattern of alternating between an illuminated state and a non-illuminated state can be adjusted based on an amount of the vaporizable material within the vapor device 100. In some aspects, the vapor device 100 may include at least two light-emitting elements positioned on each of the outlet 114 and/or the outlet 124. Each of the at least two light-emitting elements may include a first light-emitting element and an outer light-emitting element positioned nearer the end of the outlet 114 and/or the outlet 124 than the first light-emitting element. Illumination of the at least two light-emitting elements may indicate a direction of a flow of vapor.

In an aspect, input from the input/output device 112 can be used by the processor 102 to cause the vaporizer 108 to vaporize the one or more vaporizable or non-vaporizable materials. For example, a user can depress a button, causing the vaporizer 108 to start vaporizing the one or more vaporizable or non-vaporizable materials. A user can then draw on an outlet 114 to inhale the vapor. In various aspects, the processor 102 can control vapor production and flow to the outlet 114 based on data detected by a flow sensor 116. For example, as a user draws on the outlet 114, the flow sensor 116 can detect the resultant pressure and provide a signal to the processor 102. In response, the processor 102 can cause the vaporizer 108 to begin vaporizing the one or more vaporizable or non-vaporizable materials, terminate vaporizing the one or more vaporizable or non-vaporizable materials, and/or otherwise adjust a rate of vaporization of the one or more vaporizable or non-vaporizable materials. In another aspect, the vapor can exit the vapor device 100 through an outlet 124. The outlet 124 differs from the outlet 114 in that the outlet 124 can be configured to distribute the vapor into the local atmosphere, rather than being inhaled by a user. In an aspect, vapor exiting the outlet 124 can be at least one of aromatic, medicinal, recreational, and/or wellness related. In an aspect, the vapor device 100 can comprise any number of outlets. In an aspect, the outlet 114 and/or the outlet 124 can comprise at least one flexible tube. For example, a lumen of the at least one flexible tube can be in fluid communication with one or more components (e.g., a first container) of the vapor device 100 to provide vapor to a user. In more detailed aspects, the at least one flexible tube may include at least two flexible tubes. Accordingly, the vapor device 100 may further include a second container configured to receive a second vaporizable material such that a first flexible tube can receive vapor from the first vaporizable material and a second flexible tube receive vapor from the second vaporizable material. For example, the at least two flexible tubes can be in fluid. communication with the first container and with second container. The vapor device 100 may include an electrical or mechanical sensor configured to sense a pressure level, and therefore suction, in an interior of the flexible tube, Application of suction may activate the vapor device 100 and cause vapor to flow.

In another aspect, the vapor device 100 can comprise a piezoelectric dispersing element. In some aspects, the piezoelectric dispersing element can be charged by a battery, and can be driven by a processor on a circuit board. The circuit board can be produced using a polyimide such as Kapton, or other suitable material. The piezoelectric dispersing element can comprise a thin metal disc which causes dispersion of the fluid fed into the dispersing element via the wick or other soaked piece of organic material through vibration. Once in contact with the piezoelectric dispersing element, the vaporizable material (e.g., fluid) can be vaporized (e.g., turned into vapor or mist) and the vapor can be dispersed via a system pump and/or a sucking action of the user. In some aspects, the piezoelectric dispersing element can cause dispersion of the vaporizable material by producing ultrasonic vibrations. An electric field applied to a piezoelectric material within the piezoelectric element can cause ultrasonic expansion and contraction of the piezoelectric material, resulting in ultrasonic vibrations to the disc. The ultrasonic vibrations can cause the vaporizable material to disperse, thus forming a vapor or mist from the vaporizable material.

In some aspects, the connection between a power supply and the piezoelectric dispersing element can be facilitated using one or more conductive coils. The conductive coils can provide an ultrasonic power input to the piezoelectric dispersing element. For example, the signal carried by the coil can have a frequency of approximately 107.8 kHz. In some aspects, the piezoelectric dispersing element can comprise a piezoelectric dispersing element that can receive the ultrasonic signal transmitted from the power supply through the coils, and can cause vaporization of the vaporizable liquid by producing ultrasonic vibrations. An ultrasonic electric field applied to a piezoelectric material within the piezoelectric element causes ultrasonic expansion and contraction of the piezoelectric material, resulting in ultrasonic vibrations according to the frequency of the signal. The vaporizable liquid can be vibrated by the ultrasonic energy produced by the piezoelectric dispersing element, thus causing dispersal and/or atomization of the liquid. in an aspect, the vapor device 100 can be configured to permit a user to select between using a heating element of the vaporizer 108 or the piezoelectric dispersing element. In another aspect, the vapor device 100 can be configured to permit a user to utilize both a heating element of the vaporizer 108 and the piezoelectric dispersing element.

In an aspect, the vapor device 100 can comprise a heating casing 126. The heating casing 126 can enclose one or more of the container 110, the vaporizer 108, and/or the outlet 114. In a further aspect, the heating casing 126 can enclose one or more components that make up the container 110, the vaporizer 108, and/or the outlet 114, The heating casing 126 can be made of ceramic, metal, and/or porcelain. The heating casing 126 can have varying thickness. In an aspect, the heating casing 126 can be coupled to the power supply 120 to receive power to heat the heating casing 126. In another aspect, the heating casing 126 can be coupled to the vaporizer 108 to heat the heating casing 126. In another aspect, the heating casing 126 can serve an insulation role.

In an aspect, the vapor device 100 can comprise a filtration element 128. The filtration element 128 can be configured to remove (e.g., filter, purify, etc) contaminants from air entering the vapor device 100. The filtration element 128 can optionally comprise a fan 130 to assist in delivering air to the filtration element 128. The vapor device 100 can be configured to intake air into the filtration element 128, filter the air, and pass the filtered air to the vaporizer 108 for use in vaporizing the one or more vaporizable or non-vaporizable materials. In another aspect, the vapor device 100 can be configured to intake air into the filtration element 128, filter the air, and bypass the vaporizer 108 by passing the filtered air directly to the outlet 114 for inhalation by a user.

In an aspect, the filtration element 128 can comprise cotton, polymer, wool, satin, meta materials and the like. The filtration element 128 can comprise a filter material that at least one airborne particle and/or undesired gas by a mechanical mechanism, an electrical mechanism, and/or a chemical mechanism. The filter material can comprise one or more pieces of a filter fabric that can filter out one or more airborne particles and/or gasses. The filter fabric can be a woven and/or non-woven material. The filter fabric can be made from natural fibers (e.g., cotton, wool, etc.) and/or from synthetic fibers (e.g., polyester, nylon, polypropylene, etc.). The thickness of the filter fabric can be varied depending on the desired filter efficiencies and/or the region of the apparel where the filter fabric is to be used. The filter fabric can be designed to filter airborne particles and/or gasses by mechanical mechanisms (e.g., weave density), by electrical mechanisms (e.g., charged fibers, charged metals, etc.), and/or by chemical mechanisms (e.g., absorptive charcoal particles, adsorptive materials, etc.). In as aspect, the filter material can comprise electrically charged fibers such as, but not limited to, FILTRETE by 3M. In another aspect, the filter material can comprise a high density material similar to material used for medical masks which are used by medical personnel in doctors offices, hospitals, and the like. In an aspect, the filter material can be treated with an anti-bacterial solution and/or otherwise made from anti-bacterial materials. In another aspect, the filtration element 128 can comprise electrostatic plates, ultraviolet light, a HEPA filter, combinations thereof, and the like.

In an aspect, the vapor device 100 can comprise a cooling element 132. The cooling element 132 can be configured to cool vapor exiting the vaporizer 108 prior to passing through the outlet 114. The cooling element 132 can cool vapor by utilizing air or space within the vapor device 100. The air used by the cooling element 132 can be either static (existing in the vapor device 100) or drawn into an intake and through the cooling element 132 and the vapor device 100. The intake can comprise various pumping, pressure, fan, or other intake systems for drawing air into the cooling element 132. In an aspect, the cooling element 132 can reside separately or can be integrated the vaporizer 108. The cooling element 132 can be a single cooled electronic element within a tube or space and/or the cooling element 132 can be configured as a series of coils or as a grid like structure. The materials for the cooling element 132 can be metal, liquid, polymer, natural substance, synthetic substance, air, or any combination thereof. The cooling element 132 can be powered by the power supply 120, by a separate battery (not shown), or other power source (not shown) including the use of excess heat energy created by the vaporizer 108 being converted to energy used for cooling by virtue of a small turbine or pressure system to convert the energy. Heat differentials between the vaporizer 108 and the cooling element 132 can also be converted to energy utilizing commonly known geothermal energy principles.

In an aspect, the vapor device 100 can comprise a magnetic element 134. For example, the magnetic element 134 can comprise an electromagnet, a ceramic magnet, a ferrite magnet, and/or the like. The magnetic element 134 can be configured to apply a magnetic field to air as it is brought into the vapor device 100, in the vaporizer 108, and/or as vapor exits the outlet 114.

The input/output device 112 can be used to select whether vapor exiting the outlet 114 should be cooled or not cooled and/or heated or not heated and/or magnetized or not magnetized. For example, a user can use the input/output device 112 to selectively cool vapor at times and not cool vapor at other times. The user can use the input/output device 112 to selectively heat vapor at times and not heat vapor at other times. The user can use the input/output device 112 to selectively magnetize vapor at times and not magnetize vapor at other times. The user can further use the input/output device 112 to select a desired smoothness, temperature, and/or range of temperatures. The user can adjust the temperature of the vapor by selecting or clicking on a clickable setting on a part of the vapor device 100. The user can use, for example, a graphical user interface (GUI) or a mechanical input enabled by virtue of clicking a rotational mechanism at either end of the vapor device 100.

In an aspect, cooling control can be set within the vapor device 100 settings via the processor 102 and system software (e.g., dynamic linked libraries), The memory 104 can store settings. Suggestions and remote settings can be communicated to and/or from the vapor device 100 via the input/output device 112 and/or the network access device 106. Cooling of the vapor can be set and calibrated between heating and cooling mechanisms to what is deemed an ideal temperature by the manufacturer of the vapor device 100 for the vaporizable material. For example, a temperature can be set such that resultant vapor delivers the coolest feeling to the average user but does not present any health risk to the user by virtue of the vapor being too cold, including the potential for rapid expansion of cooled vapor within the lungs and the damaging of tissue by vapor which has been cooled to a temperature which may cause frostbite like symptoms.

In an aspect, the vapor device 100 can be configured to receive air, smoke, vapor or other material and analyze the contents of the air, smoke, vapor or other material using one or more sensors 136 in order to at least one of analyze, classify, compare, validate, refute, and/or catalogue the same, A result of the analysis can be, for example, an identification of at least one of medical, recreational, homeopathic, olfactory elements, spices, other cooking ingredients, ingredients analysis from food products, fuel analysis, pharmaceutical analysis, genetic modification testing analysis, dating, fossil and/or relic analysis and the like. The vapor device 100 can pass utilize, for example, mass spectrometry, PH testing, genetic testing, particle and/or cellular testing, sensor based testing and other diagnostic and wellness testing either via locally available components or by transmitting data to a remote system for analysis.

In an aspect, a user can create a custom scent by using the vapor device 100 to intake air elements, where the vapor device 100 (or third-party networked device) analyzes the olfactory elements and/or biological elements within the sample and then formulates a replica scent within the vapor device 100 (or third-party networked device) that can be accessed by the user instantly, at a later date, with the ability to purchase this custom scent from a networked ecommerce portal.

The vapor device 100 can comprise an intake. The intake can be receptacle for receiving air from an area surrounding the intake. In another aspect, the intake can be a receptacle for receiving at least a portion of a detachable vaporizer. in an aspect, the intake can form an airtight seal with a detachable vaporizer. In another aspect, the intake can form a non-airtight seal with a detachable vaporizer. The vapor device 100 can comprise a pump (or other similar suction mechanism) coupled to the intake. The pump can be configured to draw air from an area surrounding the intake. In an aspect, one or more fan 130 can be configured to assist the pump in drawing air into the vapor device 100.

Air drawn in by the pump through the intake 138 can be passed to an analysis chamber. The analysis chamber can be a receptacle within the vapor device 100 configured for holding the drawn air and for exposing the air to one or more sensors 136 in order to at least one of analyze, classify, compare, validate, refute, and/or catalogue the same. A result of the analysis can be, for example, a performance indicator for a detachable vaporizer (any measure indicative of whether a detachable vaporizer is performing as expected), an identification of at least one of medical, recreational, homeopathic, olfactory elements, spices, other cooking ingredients, ingredients analysis from food products, fuel analysis, pharmaceutical analysis, and the like. The vapor device 100 can utilize, for example, mass spectrometry, gas chromatography, PH testing, particle and/or cellular testing, sensor based testing and other diagnostic and wellness testing either via locally available components or by transmitting data to a remote system for analysis. The mass spectrometry and/or gas chromatography systems disclosed herein can be implemented in a compact form factor, as is known in the art. Mass spectrometry is an analytical chemistry technique that identifies an amount and type of chemicals present in a sample by measuring the mass-to-charge ratio and abundance of gas-phase ions. A mass spectrum (plural spectra) is a plot of the ion signal as a function of the mass-to-charge ratio. The spectra are used to determine the elemental or isotopic signature of a sample, the masses of particles and of molecules, and to elucidate the chemical structures of molecules, such as peptides and other chemical compounds. Mass spectrometry works by ionizing chemical compounds to generate charged molecules or molecule fragments and measuring their mass-to-charge ratios.

In a typical mass spectrometry procedure, a sample of the drawn air, is ionized, for example by bombarding the air/vapor with electrons. This can cause some of the sample's molecules to break into charged fragments. These ions are then separated according to their mass-to-charge ratio, typically by accelerating them and subjecting them to an electric or magnetic field: ions of the same mass-to-charge ratio will undergo the same amount of deflection. The ions are detected by a mechanism capable of detecting charged particles, such as an electron multiplier. Results are displayed as spectra of the relative abundance of detected ions as a function of the mass-to-charge ratio. The atoms or molecules in the sample can be identified by correlating known masses to the identified masses stored on the memory device 104 or through a characteristic fragmentation pattern. Thus, a composition of the drawn air can be determined.

In another aspect, nanosensor technology using nanostructures: single walled carbon nanotubes (SWNTs), combined with a silicon-based microfabrication and micromachining process can be used. This technology provides a sensor array that can accommodate different nanostructures for specific applications with the advantages of high sensitivity, low power consumption, compactness, high yield and low cost. This platform provides an array of sensing elements for chemical detection. Each sensor in the array can comprise a nanostructure—chosen from many different categories of sensing material—and an interdigitated electrode (IDE) as a transducer. It is one type of electrochemical sensor that implies the transfer of charge from one electrode to another. This means that at least two electrodes constitute an electrochemical cell to form a closed electrical circuit. Due to the interaction between nanotube devices and gas molecules, the electron configuration is changed in the nanostructured sensing device, therefore, the changes in the electronic signal such as current or voltage were observed before and during the exposure of gas species (such as NO 2, NH 3, etc.). By measuring the conductivity change of the CNT device, the concentration of the chemical species, such as gas molecules in the air/vapor drawn from the vapor device 100, can be measured.

In another aspect, the one or more sensors 136 can be configured to sense negative environmental conditions (e.g., adverse weather, smoke, fire, chemicals (e.g., such as CO2 or formaldehyde), adverse pollution, and/or disease outbreaks, and the like). The one or more sensors 136 can comprise one or more of, a biochemical/chemical sensor, a thermal sensor, a radiation sensor, a mechanical sensor, an optical sensor, a mechanical sensor, a magnetic sensor, an electrical sensor, combinations thereof and the like. The biochemical/chemical sensor can be configured to detect one or more biochemical/chemicals causing a negative environmental condition such as, but not limited to, smoke, a vapor, a gas, a liquid, a solid, an odor, combinations thereof, and/or the like. The biochemical/chemical sensor can comprise one or more of a mass spectrometer, a conducting/nonconducting regions sensor, a SAW sensor, a quartz microbalance sensor, a conductive composite sensor, a chemiresitor, a metal oxide gas sensor, an organic gas sensor, a MOSFET, a piezoelectric device, an infrared sensor, a sintered metal oxide sensor, a Pd-gate MOSFET, a metal FET structure, a electrochemical cell, a conducting polymer sensor, a catalytic gas sensor, an organic semiconducting gas sensor, a solid electrolyte gas sensors, a piezoelectric quartz crystal sensor, and/or combinations thereof.

A semiconductor sensor can be configured to detect gases by a chemical reaction that takes place when the gas comes in direct contact with the sensor. Tin dioxide is the most common material used in semiconductor sensors, and the electrical resistance in the sensor is decreased when it comes in contact with the monitored gas. The resistance of the tin dioxide is typically around 50 kΩ in air but can drop to around 3.5 kΩ in the presence of 1% methane. This change in resistance is used to calculate the gas concentration. Semiconductor sensors can be commonly used to detect hydrogen, oxygen, alcohol vapor, and harmful gases such as carbon monoxide. A semiconductor sensors can be used as a carbon monoxide sensors. A semiconductor sensor can be used as a breathalyzers. Because the sensor must come in contact with the gas to detect it, semiconductor sensors work over a smaller distance than infrared point or ultrasonic detectors.

The thermal sensor can be configured to detect temperature, heat, heat flow, entropy, heat capacity, combinations thereof, and the like, Exemplary thermal sensors include, but are not limited to, thermocouples, such as a semiconducting thermocouples, noise thermometry, thermoswitches, thermistors, metal thermoresistors, semiconducting thermoresistors, thermodiodes, thermotransistors, calorimeters, thermometers, indicators, and fiber optics.

The radiation sensor can be configured to detect gamma rays, X-rays, ultra-violet rays, visible, infrared, microwaves and radio waves. Exemplary radiation sensors include, but are not limited to, nuclear radiation microsensors, such as scintillation counters and solid state detectors, ultra-violet, visible and near infrared radiation microsensors, such as photoconductive cells, photodiodes, phototransistors, infrared radiation microsensors, such as photoconductive IR sensors and pyroelectric sensors.

The optical sensor can be configured to detect visible, near infrared, and infrared waves. The mechanical sensor can be configured to detect displacement, velocity, acceleration, force, torque, pressure, mass, flow, acoustic wavelength, and amplitude. Exemplary mechanical sensors include, but are not limited to, displacement microsensors, capacitive and inductive displacement sensors, optical displacement sensors, ultrasonic displacement sensors, pyroelectric, velocity and flow microsensors, transistor flow microsensors, acceleration microsensors, piezoresistive microaccelerometers, force, pressure and strain microsensors, and piezoelectric crystal sensors. The magnetic sensor can be configured to detect magnetic field, flux, magnetic moment, magnetization, and magnetic permeability. The electrical sensor can be configured to detect charge, current, voltage, resistance, conductance, capacitance, inductance, dielectric permittivity, polarization and frequency.

Upon sensing a negative environmental condition, the one or more sensors 122 can provide data to the processor 102 to determine the nature of the negative environmental condition and to generate/transmit one or more alerts based on the negative environmental condition. The one or more alerts can be deployed to the vapor device 100 user's wireless device and/or synced accounts. For example, the network device access device 106 can be used to transmit the one or more alerts directly (e.g., via Bluetooth®) to a user's smartphone to provide information to the user. In another aspect, the network access device 106 can be used to transmit sensed information and/or the one or more alerts to a remote server for use in syncing one or more other devices used by the user (e.g., other vapor devices, other electronic devices (smartphones, tablets, laptops, etc . . . ). In another aspect, the one or more alerts can be provided to the user of the vapor device 100 via vibrations, audio, colors, and the like deployed from the mask, for example through the input/output device 112. For example, the input/output device 112 can comprise a small vibrating motor to alert the user to one or more sensed conditions via tactile sensation. In another example, the input/output device 112 can comprise one or more LED's of various colors to provide visual information to the user. In another example, the input/output device 112 can comprise one or more speakers that can provide audio information to the user. For example, various patterns of beeps, sounds, and/or voice recordings can be utilized to provide the audio information to the user. In another example, the input/output device 112 can comprise an LCD screen/touchscreen that provides a summary and/or detailed information regarding the negative environmental condition and/or the one or more alerts.

In another aspect, upon sensing a negative environmental condition, the one or more sensors 136 can provide data to the processor 102 to determine the nature of the negative environmental condition and to provide a recommendation for mitigating and/or to actively mitigate the negative environmental condition. Mitigating the negative environmental conditions can comprise, for example, applying a filtration system, a fan, a fire suppression system, engaging a HVAC system, and/or one or more vaporizable and/or non-vaporizable materials. The processor 102 can access a database stored in the memory device 104 to make such a determination or the network device 106 can be used to request information from a server to verify the sensor findings. In an aspect, the server can provide an analysis service to the vapor device 100. For example, the server can analyze data sent by the vapor device 100 based on a reading from the one or more sensors 136. The server can determine and transmit one or more recommendations to the vapor device 100 to mitigate the sensed negative environmental condition. The vapor device 100 can use the one or more recommendations to activate a filtration system, a fan, a fire suppression system engaging a HVAC system, and/or to vaporize one or more vaporizable or non-vaporizable materials to assist in countering effects from the negative environmental condition.

In an aspect, the vapor device 100 can comprise a global positioning system (GPS) unit 118. The GPS 118 can detect a current location of the device 100. In some aspects, a user can request access to one or more services that rely on a current location of the user. For example, the processor 102 can receive location data from the GPS 118, convert it to usable data, and transmit the usable data to the one or more services via the network access device 106. GPS unit 118 can receive position information from a constellation of satellites operated by the U.S. Department of Defense. Alternately, the GPS unit 118 can be a GLONASS receiver operated by the Russian Federation Ministry of Defense, or any other positioning device capable of providing accurate location information (for example, LORAN, inertial navigation, and the like). The GPS unit 118 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range.

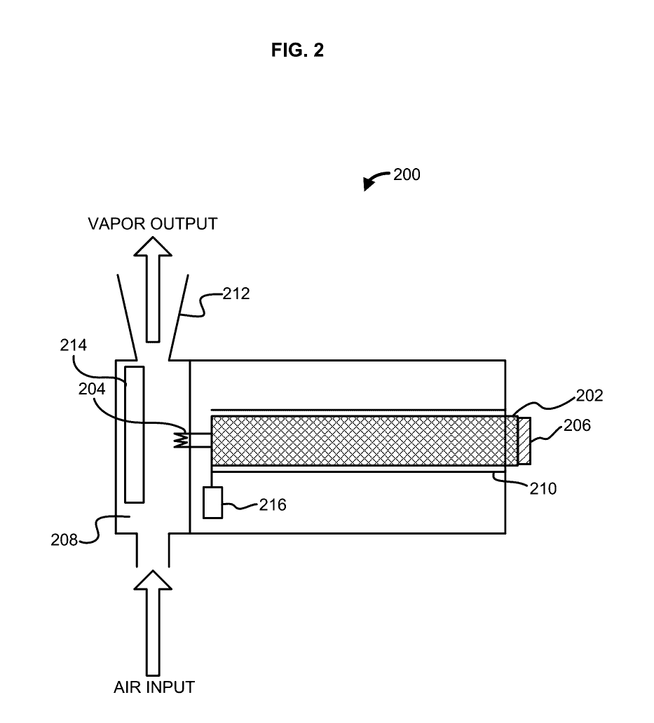

FIG. 2 illustrates an exemplary vaporizer 200. The vaporizer 200 can be, for example, an e-cigarette, an e-cigar, an electronic vapor device, a hybrid electronic communication handset coupled/integrated vapor device, a robotic vapor device, a modified vapor device “mod,” a micro-sized electronic vapor device, a robotic vapor device, and the like. The vaporizer 200 can be used internally of the vapor device 100 or can be a separate device. For example, the vaporizer 200 can be used in place of the vaporizer 108.

The vaporizer 200 can comprise or be coupled to one or more containers 202 containing a vaporizable material, for example a fluid. For example, coupling between the vaporizer 200 and the one or more containers 202 can be via a wick 204, via a valve, or by some other structure. Coupling can operate independently of gravity, such as by capillary action or pressure drop through a valve. The vaporizer 200 can be configured to vaporize the vaporizable material from the one or more containers 202 at controlled rates in response to mechanical input from a component of the vapor device 100, and/or in response to control signals from the processor 102 or another component. Vaporizable material (e.g., fluid) can be supplied by one or more replaceable cartridges 206. In an aspect the vaporizable material can comprise aromatic elements. In an aspect, the aromatic elements can be medicinal, recreational, and/or wellness related. The aromatic element can include, but is not limited to, at least one of lavender or other floral aromatic eLiquids, mint, menthol, herbal soil or geologic, plant based, name brand perfumes, custom mixed perfume formulated inside the vapor device 100 and aromas constructed to replicate the smell of different geographic places, conditions, and/or occurrences. For example, the smell of places may include specific or general sports venues, well known travel destinations, the mix of one's own personal space or home. The smell of conditions may include, for example, the smell of a pet, a baby, a season, a general environment (e.g., a forest), a new car, a sexual nature (e.g., musk, pheromones, etc . . . ). The one or more replaceable cartridges 206 can contain the vaporizable material. If the vaporizable material is liquid, the cartridge can comprise the wick 204 to aid in transporting the liquid to a mixing chamber 208. In the alternative, some other transport mode can be used. Each of the one or more replaceable cartridges 206 can be configured to fit inside and engage removably with a receptacle (such as the container 202 and/or a secondary container) of the vapor device 100. In an alternative, or in addition, one or more fluid containers 210 can be fixed in the vapor device 100 and configured to be refillable. In an aspect, one or more materials can be vaporized at a single time by the vaporizer 200. For example, some material can be vaporized and drawn through an exhaust port 212 and/or some material can be vaporized and exhausted via a smoke simulator outlet (not shown).

The mixing chamber 208 can also receive an amount of one or more compounds (e.g., vaporizable material) to be vaporized. For example, the processor 102 can determine a first amount of a first compound and determine a second amount of a second compound. The processor 102 can cause the withdrawal of the first amount of the first compound from a first container into the mixing chamber and the second amount of the second compound from a second container into the mixing chamber. The processor 102 can also determine a target dose of the first compound, determine a vaporization ratio of the first compound and the second compound based on the target dose, determine the first amount of the first compound based on the vaporization ratio, determine the second amount of the second compound based on the vaporization ratio, and cause the withdrawal of the first amount of the first compound into the mixing chamber, and the withdrawal of the second amount of the second compound into the mixing chamber.

The processor 102 can also determine a target dose of the first compound, determine a vaporization ratio of the first compound and the second compound based on the target dose, determine the first amount of the first compound based on the vaporization ratio, and determine the second amount of the second compound based on the vaporization ratio. After expelling the vapor through an exhaust port for inhalation by a user, the processor 102 can determine that a cumulative dose is approaching the target dose and reduce the vaporization ratio. In an aspect, one or more of the vaporization ratio, the target dose, and/or the cumulative dose can be determined remotely and transmitted to the vapor device 100 for use.

In operation, a heating element 214 can vaporize or nebulize the vaporizable material in the mixing chamber 208, producing an inhalable vapor/mist that can be expelled via the exhaust port 212. In an aspect, the heating element 214 can comprise a heater coupled to the wick (or a heated wick) 204 operatively coupled to (for example, in fluid communication with) the mixing chamber 210. The heating element 214 can comprise a nickel-chromium wire or the like, with a temperature sensor (not shown) such as a thermistor or thermocouple. Within definable limits, by controlling power to the wick 204, a rate of vaporization can be independently controlled. A multiplexer 216 can receive power from any suitable source and exchange data signals with a processor, for example, the processor 102 of the vapor device 100, for control of the vaporizer 200. At a minimum, control can be provided between no power (off state) and one or more powered states. Other control mechanisms can also be suitable.

In another aspect, the vaporizer 200 can comprise a piezoelectric dispersing element. In some aspects, the piezoelectric dispersing element can be charged by a battery, and can be driven by a processor on a circuit board. The circuit board can be produced using a polyimide such as Kapton, or other suitable material. The piezoelectric dispersing element can comprise a thin metal disc which causes dispersion of the fluid fed into the dispersing element via the wick or other soaked piece of organic material through vibration. Once in contact with the piezoelectric dispersing element, the vaporizable material (e.g., fluid) can be vaporized (e.g., turned into vapor or mist) and the vapor can be dispersed via a system pump and/or a sucking action of the user. In some aspects, the piezoelectric dispersing element can cause dispersion of the vaporizable material by producing ultrasonic vibrations. An electric field applied to a piezoelectric material within the piezoelectric element can cause ultrasonic expansion and contraction of the piezoelectric material, resulting in ultrasonic vibrations to the disc. The ultrasonic vibrations can cause the vaporizable material to disperse, thus forming a vapor or mist from the vaporizable material.

In an aspect, the vaporizer 200 can be configured to permit a user to select between using the heating element 214 or the piezoelectric dispersing element. In another aspect, the vaporizer 200 can be configured to permit a user to utilize both the heating element 214 and the piezoelectric dispersing element.

In some aspects, the connection between a power supply and the piezoelectric dispersing element can be facilitated using one or more conductive coils. The conductive coils can provide an ultrasonic power input to the piezoelectric dispersing element. For example, the signal carried by the coil can have a frequency of approximately 107.8 kHz, in some aspects, the piezoelectric dispersing element can comprise a piezoelectric dispersing element that can receive the ultrasonic signal transmitted from the power supply through the coils, and can cause vaporization of the vaporizable liquid by producing ultrasonic vibrations. An ultrasonic electric field applied to a piezoelectric material within the piezoelectric element causes ultrasonic expansion and contraction of the piezoelectric material, resulting in ultrasonic vibrations according to the frequency of the signal. The vaporizable liquid can be vibrated by the ultrasonic energy produced by the piezoelectric dispersing element, thus causing dispersal and/or atomization of the liquid.

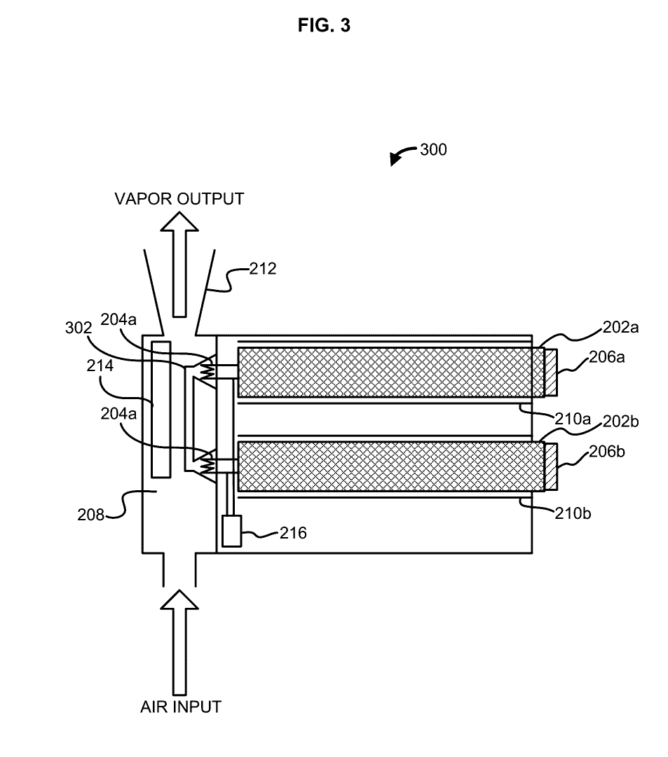

FIG. 3 illustrates a vaporizer 300 that comprises the elements of the vaporizer 200 with two containers 202a and 202b containing a vaporizable material, for example a fluid or a solid. In an aspect, the fluid can be the same fluid in both containers or the fluid can be different in each container. In an aspect the fluid can comprise aromatic elements. The aromatic element can include, but is not limited to, at least one of lavender or other floral aromatic eLiquids, mint, menthol, herbal soil or geologic, plant based, name brand perfumes, custom mixed perfume formulated inside the vapor device 100 and aromas constructed to replicate the smell of different geographic places, conditions, and/or occurrences. For example, the smell of places may include specific or general sports venues, well known travel destinations, the mix of one's own personal space or home. The smell of conditions may include, for example, the smell of a pet, a baby, a season, a general environment (e.g., a forest), a new car, a sexual nature (e.g., musk, pheromones, etc . . . ). Coupling between the vaporizer 200 and the container 202a and the container 202b can be via a wick 204a and a wick 20413, respectively, via a valve, or by some other structure. Coupling can operate independently of gravity, such as by capillary action or pressure drop through a valve. The vaporizer 300 can be configured to mix in varying proportions the fluids contained in the container 202a and the container 202b and vaporize the mixture at controlled rates in response to mechanical input from a component of the vapor device 100, and/or in response to control signals from the processor 102 or another component. For example, based on a vaporization ratio. In an aspect, a mixing element 302 can be coupled to the container 202a and the container 202b. The mixing element can, in response to a control signal from the processor 102, withdraw select quantities of vaporizable material in order to create a customized mixture of different types of vaporizable material. Vaporizable material (e.g., fluid) can be supplied by one or more replaceable cartridges 206a and 206b. The one or more replaceable cartridges 206a and 206b can contain a vaporizable material. If the vaporizable material is liquid, the cartridge can comprise the wick 204a or 204b to aid in transporting the liquid to a mixing chamber 208. In the alternative, some other transport mode can be used. Each of the one or more replaceable cartridges 206a and 206b can be configured to fit inside and engage removably with a receptacle (such as the container 202a or the container 202b and/or a secondary container) of the vapor device 100. In an alternative, or in addition, one or more fluid containers 210a and 210b can be fixed in the vapor device 100 and configured to be refillable. In an aspect, one or more materials can be vaporized at a single time by the vaporizer 300. For example, some material can be vaporized and drawn through an exhaust port 212 and/or some material can be vaporized and exhausted via a smoke simulator outlet (not shown).

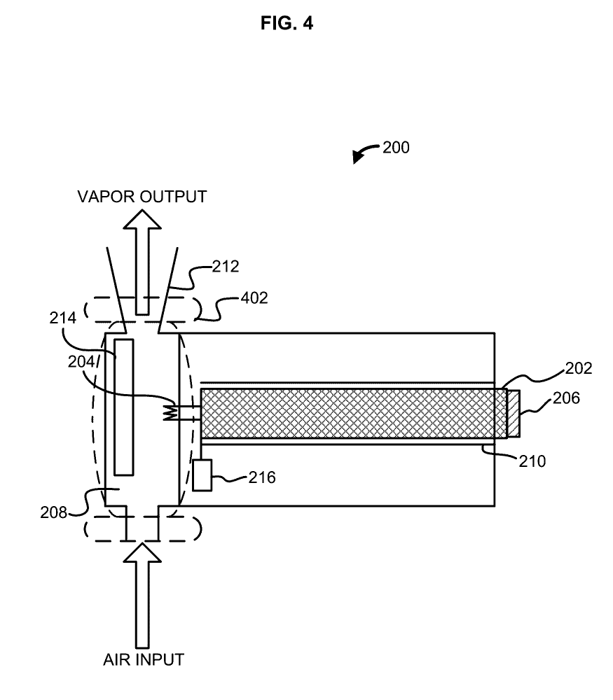

FIG. 4 illustrates a vaporizer 200 that comprises the elements of the vaporizer 200 with a heating casing 402. The heating casing 402 can enclose the heating element 214 or can be adjacent to the heating element 214. The heating casing 402 is illustrated with dashed lines, indicating components contained therein. The heating casing 402 can be made of ceramic, metal, and/or porcelain. The heating casing 402 can have varying thickness. In an aspect, the heating casing 402 can be coupled to the multiplexer 216 to receive power to heat the heating casing 402. In another aspect, the heating casing 402 can be coupled to the heating element 214 to heat the heating casing 402 in another aspect, the heating casing 402 can serve an insulation role.

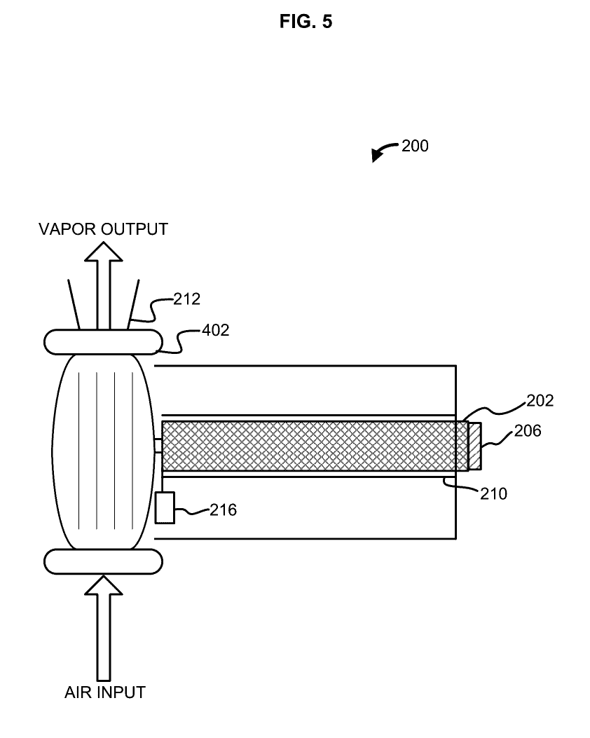

FIG. 5 illustrates the vaporizer 200 of FIG. 2 and FIG. 4, but illustrates the heating casing 402 with solid lines, indicating components contained therein. Other placements of the heating casing 402 are contemplated. For example, the heating casing 402 can be placed after the heating element 214 and/or the mixing chamber 208.

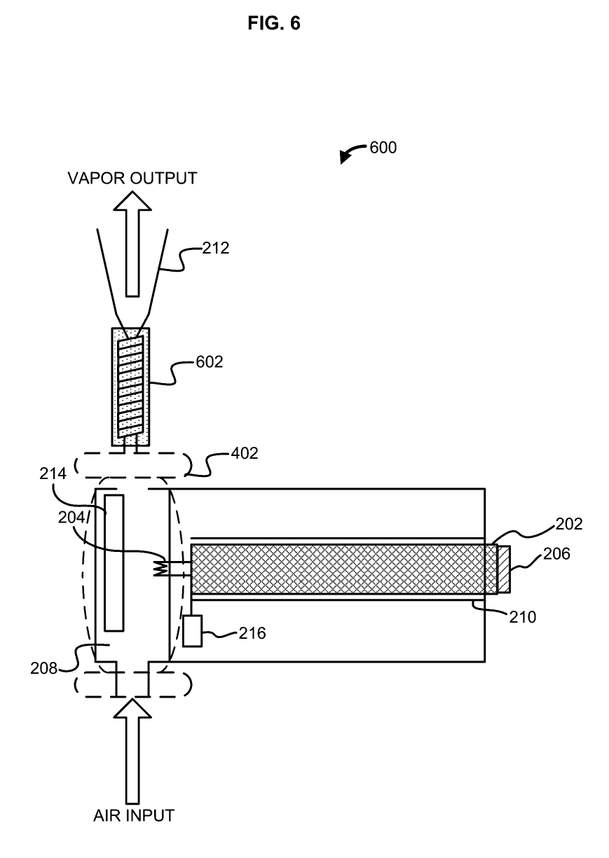

FIG. 6 illustrates a vaporizer 600 that comprises the elements of the vaporizer 200 of FIG. 2 and FIG. 4, with the addition of a cooling element 602. The vaporizer 600 can optionally comprise the heating casing 402. The cooling element 602 can comprise one or more of a powered cooling element, a cooling air system, and/or or a cooling fluid system. The cooling element 602 can be self-powered, co-powered, or directly powered by a battery and/or charging system within the vapor device 100 (e.g., the power supply 120). In an aspect, the cooling element 602 can comprise an electrically connected conductive coil, grating, and/or other design to efficiently distribute cooling to the at least one of the vaporized and/or non-vaporized air. For example, the cooling element 602 can be configured to cool air as it is brought into the vaporizer 600/mixing chamber 208 and/or to cool vapor after it exits the mixing chamber 208. The cooling element 602 can be deployed such that the cooling element 602 is surrounded by the heated casing 402 and/or the heating element 214. In another aspect, the heated casing 402 and/or the heating element 214 can be surrounded by the cooling element 602. The cooling element 602 can utilize at least one of cooled air, cooled liquid, and/or cooled matter.

In an aspect, the cooling element 602 can be a coil of any suitable length and can reside proximate to the inhalation point of the vapor (e.g., the exhaust port 212). The temperature of the air is reduced as it travels through the cooling element 602. In an aspect, the cooling element 602 can comprise any structure that accomplishes a cooling effect. For example, the cooling element 602 can be replaced with a screen with a mesh or grid-like structure, a conical structure, and/or a series of cooling airlocks, either stationary or opening, in a periscopic/telescopic manner. The cooling element 602 can be any shape and/or can take multiple forms capable of cooling heated air, which passes through its space.

In an aspect, the cooling element 602 can be any suitable cooling system for use in a vapor device. For example, a fan, a heat sink, a liquid cooling system, a chemical cooling system, combinations thereof, and the like. In an aspect, the cooling element 602 can comprise a liquid cooling system whereby a fluid (e.g., water) passes through pipes in the vaporizer 600. As this fluid passes around the cooling element 602, the fluid absorbs heat, cooling air in the cooling element 602. After the fluid absorbs the heat, the fluid can pass through a heat exchanger which transfers the heat from the fluid to air blowing through the heat exchanger. By way of further example, the cooling element 602 can comprise a chemical cooling system that utilizes an endothermic reaction. An example of an endothermic reaction is dissolving ammonium nitrate in water. Such endothermic process is used in instant cold packs. These cold packs have a strong outer plastic layer that holds a bag of water and a chemical, or mixture of chemicals, that result in an endothermic reaction when dissolved in water. When the cold pack is squeezed, the inner bag of water breaks and the water mixes with the chemicals. The cold pack starts to cool as soon as the inner bag is broken, and stays cold for over an hour. Many instant cold packs contain ammonium nitrate. When ammonium nitrate is dissolved in water, it splits into positive ammonium ions and negative nitrate ions. In the process of dissolving, the water molecules contribute energy, and as a result, the water cools down. Thus, the vaporizer 600 can comprise a chamber for receiving the cooling element 602 in the form of a “cold pack.” The cold pack can be activated prior to insertion into the vaporizer 600 or can be activated after insertion through use of a button/switch and the like to mechanically activate the cold pack inside the vaporizer 400.

In an aspect, the cooling element 602 can be selectively moved within the vaporizer 600 to control the temperature of the air mixing with vapor. For example, the cooling element 602 can be moved closer to the exhaust port 212 or further from the exhaust port 212 to regulate temperature. In another aspect, insulation can be incorporated as needed to maintain the integrity of heating and cooling, as well as absorbing any unwanted condensation due to internal or external conditions, or a combination thereof. The insulation can also be selectively moved within the vaporizer 600 to control the temperature of the air mixing with vapor. For example, the insulation can be moved to cover a portion, none, or all of the cooling element 602 to regulate temperature.

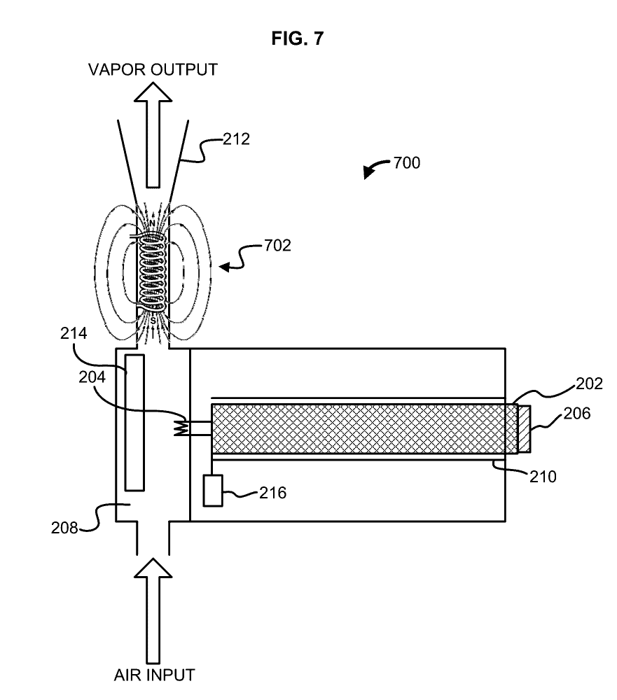

FIG. 7 illustrates a vaporizer 700 that comprises elements in common with the vaporizer 200. The vaporizer 700 can optionally comprise the heating casing 402 (not shown) and/or the cooling element 602 (not shown). The vaporizer 700 can comprise a magnetic element 702. The magnetic element 702 can apply a magnetic field to vapor after exiting the mixing chamber 208. The magnetic field can cause positively and negatively charged particles in the vapor to curve in opposite directions, according to the Lorentz force law with two particles of opposite charge. The magnetic field can be created by at least one of an electric current generating a charge or a pre-charged magnetic material deployed within the vapor device 100. In an aspect, the magnetic element 702 can be built into the mixing chamber 208, the cooling element 602, the heating casing 402, or can be a separate magnetic element 702.

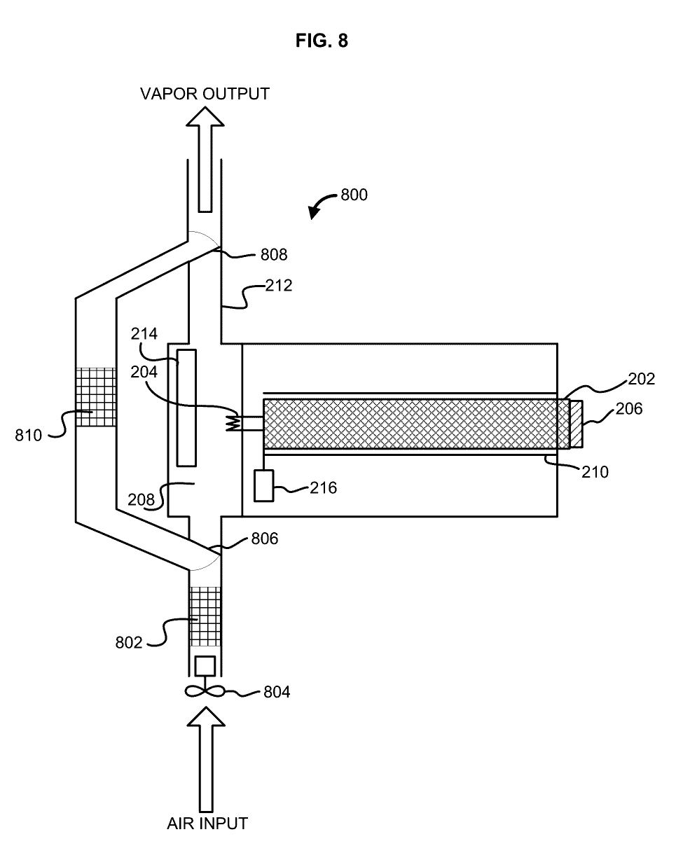

FIG. 8 illustrates a vaporizer 800 that comprises elements in common with the vaporizer 200. In an aspect, the vaporizer 800 can comprise a filtration element 802. The filtration element 802 can be configured to remove (e.g., filter, purify, etc) contaminants from air entering the vaporizer 800. The filtration element 802 can optionally comprise a fan 804 to assist in delivering air to the filtration element 802. The vaporizer 800 can be configured to intake air into the filtration element 802, filter the air, and pass the filtered air to the mixing chamber 208 for use in vaporizing the one or more vaporizable or non-vaporizable materials. In another aspect, the vaporizer 800 can be configured to intake air into the filtration element 802, filter the air, and bypass the mixing chamber 208 by engaging a door 806 and a door 808 to pass the filtered air directly to the exhaust port 212 for inhalation by a user. In an aspect, filtered air that bypasses the mixing chamber 208 by engaging the door 806 and the door 808 can pass through a second filtration element 810 to further remove (e.g., filter, purify, etc) contaminants from air entering the vaporizer 800. In an aspect, the vaporizer 800 can be configured to deploy and/or mix a proper/safe amount of oxygen which can be delivered either via the one or more replaceable cartridges 206 or via air pumped into a mask from external air and filtered through the filtration element 802 and/or the filtration element 810.

In an aspect, the filtration element 802 and/or the filtration element 810 can comprise cotton, polymer, wool, satin, meta materials and the like. The filtration element 802 and/or the filtration element 810 can comprise a filter material that at least one airborne particle and/or undesired gas by a mechanical mechanism, an electrical mechanism, and/or a chemical mechanism. The filter material can comprise one or more pieces of, a filter fabric that can filter out one or more airborne particles and/or gasses. The fitter fabric can be a woven and/or non-woven material. The filter fabric can be made from natural fibers (e.g., cotton, wool, etc.) and/or from synthetic fibers e.g., polyester, nylon, polypropylene, etc.). The thickness of the filter fabric can be varied depending on the desired filter efficiencies and/or the region of the apparel where the filter fabric is to be used. The filter fabric can be designed to filter airborne particles and/or gasses by mechanical mechanisms (e.g., weave density), by electrical mechanisms (e.g., charged fibers, charged metals, etc.), and/or by chemical mechanisms (e.g., absorptive charcoal particles, adsorptive materials, etc.). In as aspect, the filter material can comprise electrically charged fibers such as, but not limited to, FILTRETE by 3M. In another aspect, the filter material can comprise a high density material similar to material used for medical masks which are used by medical personnel in doctors' offices, hospitals, and the like. In an aspect, the filter material can be treated with an anti-bacterial solution and/or otherwise made from anti-bacterial materials. In another aspect, the filtration element 802 and/or the filtration element 810 can comprise electrostatic plates, ultraviolet light, a HEPA filter, combinations thereof, and the like.

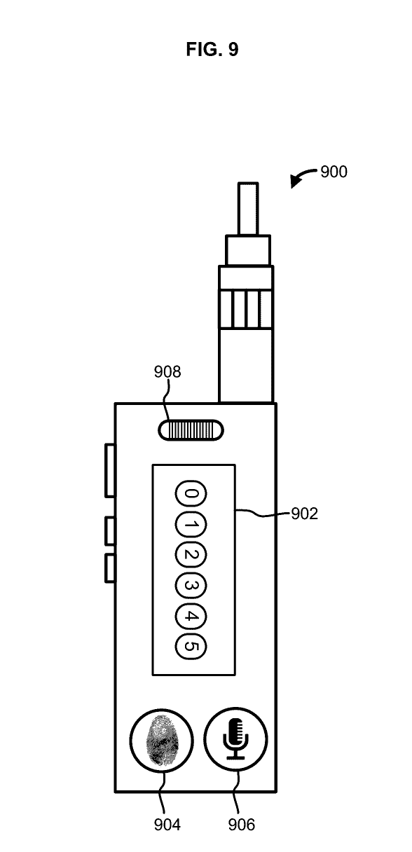

FIG. 9 illustrates an exemplary vapor device 900. The exemplary vapor device 900 can comprise the vapor device 100 and/or any of the vaporizers disclosed herein. The exemplary vapor device 900 illustrates a display 902. The display 902 can be a touchscreen. The display 902 can be configured to enable a user to control any and/or all functionality of the exemplary vapor device 900. For example, a user can utilize the display 902 to enter a pass code to lock and/or unlock the exemplary vapor device 900. The exemplary vapor device 900 can comprise a biometric interface 904. For example, the biometric interface 904 can comprise a fingerprint scanner, an eye scanner, a facial scanner, and the like. The biometric interface 904 can be configured to enable a user to control any and/or all functionality of the exemplary vapor device 900. The exemplary vapor device 900 can comprise an audio interface 906. The audio interface 906 can comprise a button that, when engaged, enables a microphone 908. The microphone 908 can receive audio signals and provide the audio signals to a processor for interpretation into one or more commands to control one or more functions of the exemplary vapor device 900.

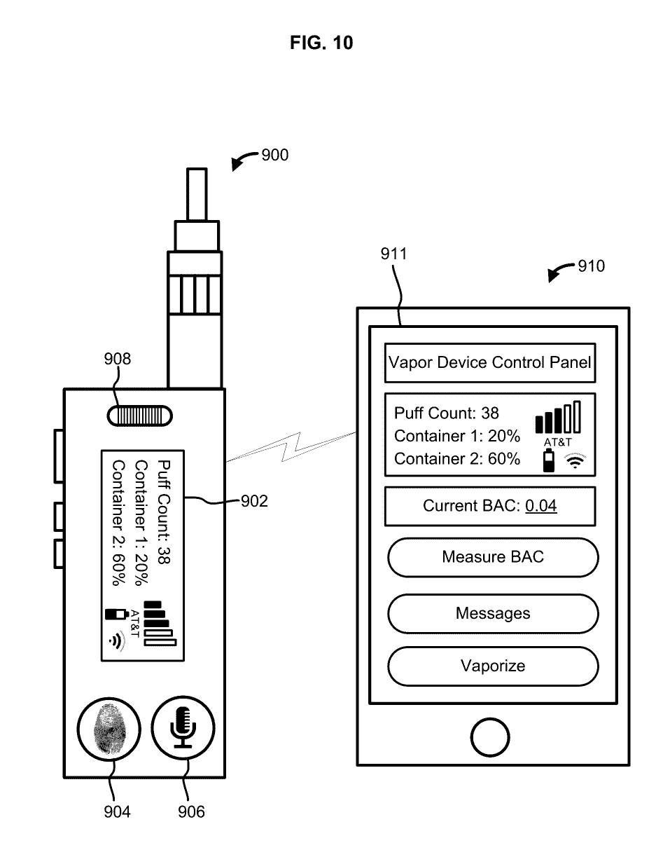

FIG. 10 illustrates exemplary information that can be provided to a user via the display 902 of the exemplary vapor device 900 or via a display 911 of an electronic device 910 in communication with the exemplary vapor device 900. The display 902 can provide information to a user such as a puff count, an amount of vaporizable material remaining in one or more containers, battery remaining, signal strength, combinations thereof, and the like. The display 911 can provide the same or different information to the user as available on the display 902. In an aspect, the exemplary vapor device 900 does not comprise the display 902. The display 911 can provide a user interface that provides information and provides control over one or more functions of the exemplary vapor device 900. The one or more functions can comprise one or more of a community function, an e-commerce function, or a vapor device operability function. The community function can comprise at least one of a social networking function, transmitting or receiving a recommendation, transmitting or receiving a message, or transmitting or receiving a location of a user. The e-commerce function can comprise at least one of purchasing a component for use with the vapor device, purchasing a vaporizable or non-vaporizable material for use with the vapor device, purchasing another vapor device or components thereof, selling a component for use with the vapor device or another vapor device, selling a vaporizable or non-vaporizable material for use with the vapor device, or selling the vapor device or another vapor device. The device operability function can comprise at least one of controlling the vapor device, displaying diagnostic information, displaying repair information, displaying calibration information, displaying usage information, or displaying information corresponding to detected constituents of material vaporized by the vapor device.

The user interface can comprise at least one of a lighted signal light, a gauge, a representation of a box, a representation of a form, a check mark, an avatar, a visual image, a graphic design, a list, an active calibration or calculation, a 2-dimensional fractal design, a 3-dimensional fractal design, a 2-dimensional representation of the vapor device or another vapor device, or a 3-dimensional representation of the vapor device or another vapor device. At least one of the 2-dimensional fractal design or the 3-dimensional fractal design can continuously or periodically expand or contract to various scales of the original fractal design.

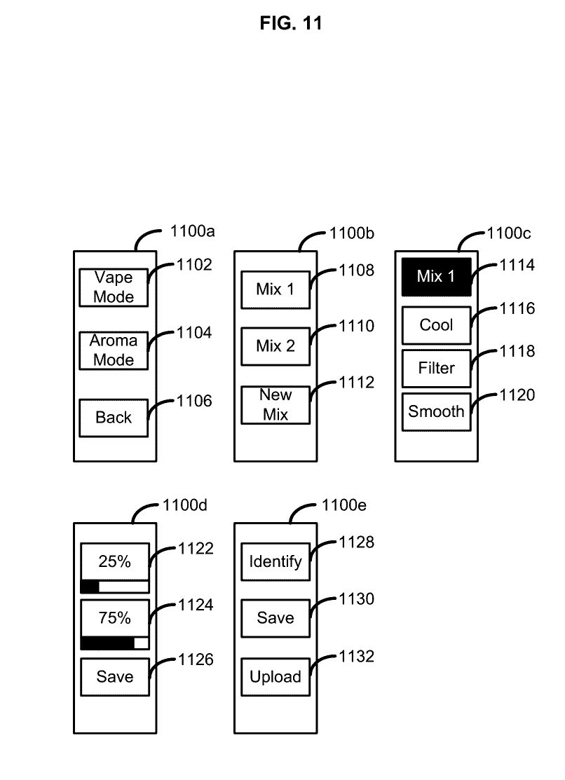

FIG. 11 illustrates a series of user interfaces that can be provided via the display 902 of the exemplary vapor device 900 or via the display 911 of the electronic device 910 in communication with the exemplary vapor device 900. In an aspect, the exemplary vapor device 900 can be configured for one or more of multi-mode vapor usage. For example, the exemplary vapor device 900 can be configured to enable a user to inhale vapor (vape mode) or to release vapor into the atmosphere (aroma mode). User interface 1100a provides a user with interface elements to select which mode the user wishes to engage, a Vape Mode 1102, an Aroma Mode 1104, or an option to go back 1106 and return to the previous screen. The interface element Vape Mode 1102 enables a user to engage a vaporizer to generate a vapor for inhalation. The interface element Aroma Mode 1104 enables a user to engage the vaporizer to generate a vapor for release into the atmosphere.

In the event a user selects the Vape Mode 1102, the exemplary vapor device 900 will be configured to vaporize material and provide the resulting vapor to the user for inhalation. The user can be presented with user interface 1100b which provides the user an option to select interface elements that will determine which vaporizable material to vaporize. For example, an option of Mix 1 1108, Mix 2 1110, or a New Mix 1112. The interface element Mix 1 1108 enables a user to engage one or more containers that contain vaporizable material in a predefined amount and/or ratio, in an aspect, a selection of Mix 1 1108 can result in the exemplary vapor device 900 engaging a single container containing a single type of vaporizable material or engaging a plurality of containers containing a different types of vaporizable material in varying amounts. The interface element Mix 2 1110 enables a user to engage one or more containers that contain vaporizable material in a predefined amount and/or ratio. In an aspect, a selection of Mix 2 1110 can result in the exemplary vapor device 900 engaging a single container containing a single type of vaporizable material or engaging a plurality of containers containing a different types of vaporizable material in varying amounts. In an aspect, a selection of New Mix 1112 can result in the exemplary vapor device 900 receiving a new mixture, formula, recipe, etc . . . of vaporizable materials and/or engage one or more containers that contain vaporizable material in the new mixture.

Upon selecting, for example, the Mix 1 1108, the user can be presented with user interface 1100e. User interface 1100c indicates to the user that Mix 1 has been selected via an indicator 1114. The user can be presented with options that control how the user wishes to experience the selected vapor. The user can be presented with interface elements Cool 1116, Filter 1118, and Smooth 1120, The interface element Cool 1116 enables a user to engage one or more cooling elements to reduce the temperature of the vapor. The interface element Filter 1118 enables a user to engage one or more filter elements to filter the air used in the vaporization process. The interface element Smooth 1120 enables a user to engage one or more heating casings, cooling elements, filter elements, and/or magnetic elements to provide the user with a smoother vaping experience.

Upon selecting New Mix 1112, the user can be presented with user interface 1100d. User interface 1100d provides the user with a container one ratio interface element 1122, a container two ratio interface element 1124, and Save 1126. The container one ratio interface element 1122 and the container two ratio interface element 1124 provide a user the ability to select an amount of each type of vaporizable material contained in container one and/or container two to utilize as a new mix. The container one ratio interface element 1122 and the container two ratio interface element 1124 can provide a user with a slider that adjusts the percentages of each type of vaporizable material based on the user dragging the slider. In an aspect, a mix can comprise 100% on one type of vaporizable material or any percent combination (e.g., 50/50, 75/25, 85/15, 95/5, etc . . . ). Once the user is satisfied with the new mix, the user can select Save 1126 to save the new mix for later use.

In the event a user selects the Aroma Mode 1104, the exemplary vapor device 900 will be configured to vaporize material and release the resulting vapor into the atmosphere. The user can be presented with user interface 1100b, 1100c, and/or 1100d as described above, but the resulting vapor will be released to the atmosphere.

In an aspect, the user can be presented with user interface 1100e. The user interface 1100e can provide the user with interface elements identify 1128, Save 1130, and Upload 1132. The interface element Identify 1128 enables a user to engage one or more sensors in the exemplary vapor device 900 to analyze the surrounding environment. For example, activating the interface element Identify 1128 can engage a sensor to determine the presence of a negative environmental condition such as smoke, a bad smell, chemicals, etc. Activating the interface element Identify 1128 can engage a sensor to determine the presence of a positive environmental condition, for example, an aroma. The interface element Save 1130 enables a user to save data related to the analyzed negative and/or positive environmental condition in memory local to the exemplary vapor device 900. The interface element Upload 1132 enables a user to engage a network access device to transmit data related to the analyzed negative and/or positive environmental condition to a remote server for storage and/or analysis.

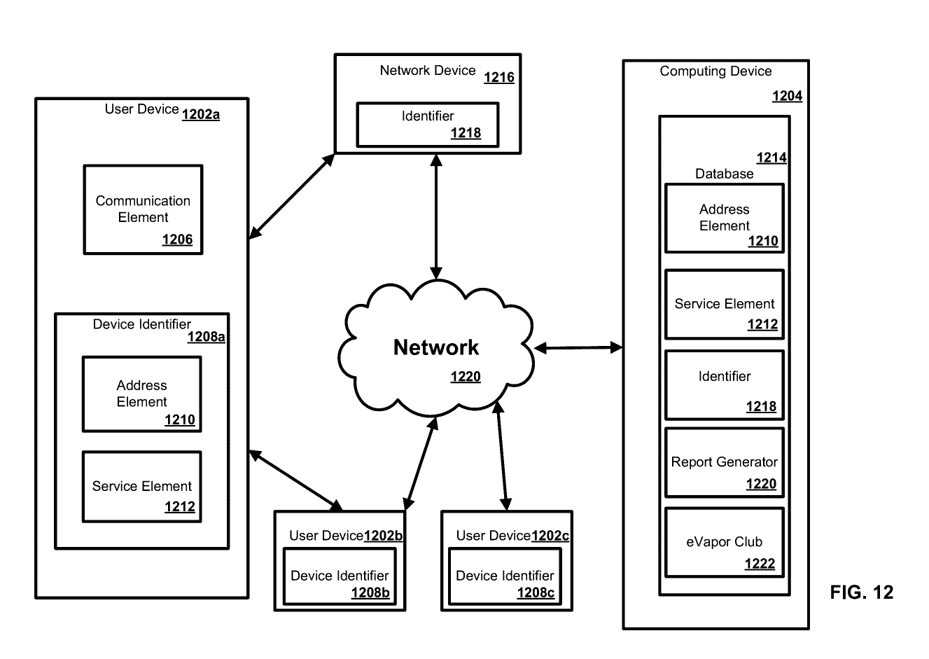

In one aspect of the disclosure, a system can be configured to provide services such as network-related services to a user device. FIG. 12 illustrates various aspects of an exemplary environment in which the present methods and systems can operate. The present disclosure is relevant to systems and methods for providing services to a user device, for example, electronic vapor devices which can include, but are not limited to, a vape-bot, micro-vapor device, vapor pipe, e-cigarette, hybrid handset and vapor device, and the like. Other user devices that can be used in the systems and methods include, but are not limited to, a smart watch (and any other form of “smart” wearable technology), a smartphone, a tablet, a laptop, a desktop, and the like. In an aspect, one or more network devices can be configured to provide various services to one or more devices, such as devices located at or near a premises. In another aspect, the network devices can be configured to recognize an authoritative device for the premises and/or a particular service or services available at the premises. As an example, an authoritative device can be configured to govern or enable connectivity to a network such as the Internet or other remote resources, provide address and/or configuration services like DHCP, and/or provide naming or service discovery services for a premises, or a combination thereof. Those skilled in the art will appreciate that present methods can be used in various types of networks and systems that employ both digital and analog equipment. One skilled in the art will appreciate that provided herein is a functional description and that the respective functions can be performed by software, hardware, or a combination of software and hardware.

The network and system can comprise a user device 1202a, 1202b, and/or 1202c in communication with a computing device 1204 such as a server, for example. The computing device 1204 can be disposed locally or remotely relative to the user device 1202a, 1202b, and/or 1202c. As an example, the user device 1202a, 1202b, and/or 1202c and the computing device 1204 can be in communication via a private and/or public network 1220 such as the Internet or a local area network. Other forms of communications can be used such as wired and wireless telecommunication channels, for example. In another aspect, the user device 1202a, 1202b, and/or 1202c can communicate directly without the use of the network 1220 (for example, via Bluetooth®, infrared, and the like),

In an aspect, the user device 1202a, 1202b, and/or 1202c can be an electronic device such as an electronic vapor device (e.g., vape-bot, micro-vapor device, vapor pipe, e-cigarette, hybrid handset and vapor device), a smartphone, a smart watch, a computer, a smartphone, a laptop, a tablet, a set top box, a display device, or other device capable of communicating with the computing device 1204. As an example, the user device 1202a, 1202b, and/or 1202c can comprise a communication element 1206 for providing an interface to a user to interact with the user device 1202a, 1202b, and/or 1202c and/or the computing device 1204. The communication element 1206 can be any interface for presenting and/or receiving information to/from the user, such as user feedback. An example interface can be communication interface such as a web browser (e.g., Internet Explorer, Mozilla Firefox, Google Chrome, Safari, or the like). Other software, hardware, and/or interfaces can be used to provide communication between the user and one or more of the user device 1202a, 1202b, and/or 1202c and the computing device 1204. In an aspect, the user device 1202a, 1202b, and/or 1202c can have at least one similar interface quality such as a symbol, a voice activation protocol, a graphical coherence, a startup sequence continuity element of sound, light, vibration or symbol. In an aspect, the interface can comprise at least one of lighted signal lights, gauges, boxes, forms, words, video, audio scrolling, user selection systems, vibrations, check marks, avatars, matrix, visual images, graphic designs, lists, active calibrations or calculations, 2D interactive fractal designs, 3D fractal designs, 2D and/or 3D representations of vapor devices and other interface system functions.

As an example, the communication element 1206 can request or query various files from a local source and/or a remote source. As a further example, the communication element 1206 can transmit data to a local or remote device such as the computing device 1204. In an aspect, data can be shared anonymously with the computing device 1204. The data can be shared over a transient data session with the computing device 1204. The transient data session can comprise a session limit. The session limit can be based on one or more of a number of puffs, a time limit, and a total quantity of vaporizable material. The data can comprise usage data and/or a usage profile. The computing device 1204 can destroy the data once the session limit is reached.

In an aspect, the user device 1202a, 1202b, and/or 1202c can be associated with a user identifier or device identifier 1208a, 1208b, and/or 1208c. As an example, the device identifier 1208a, 1208b, and/or 1208c can be any identifier, token, character, string, or the like, for differentiating one user or user device (e.g., user device 1202a, 1202b, and/or 1202c) from another user or user device. In a further aspect, the device identifier 1208a, 1208b, and/or 1208c can identify a user or user device as belonging to a particular class of users or user devices, As a further example, the device identifier 1208a, 1208b, and/or 1208c can comprise information relating to the user device such as a manufacturer, a model or type of device, a service provider associated with the user device 1202a, 1202b, and/or 1202c, a state of the user device 1202a, 1202b, and/or 1202c, a locator, and/or a label or classifier. Other information can be represented by the device identifier 1208a, 1208b, and/or 1208c.

In an aspect, the device identifier 1208a, 1208b, and/or 1208c can comprise an address element 1210 and a service element 1212. In an aspect, the address element 1210 can comprise or provide an internet protocol address, a network address, a media access control (MAC) address, an Internet address, or the like. As an example, the address element 1210 can be relied upon to establish a communication session between the user device 1202a, 1202b, and/or 1202c and the computing device 1204 or other devices and/or networks. As a further example, the address element 1210 can be used as an identifier or locator of the user device 1202a, 1202b, and/or 1202c. In an aspect, the address element 1210 can be persistent for a particular network.

In an aspect, the service element 1212 can comprise an identification of a service provider associated with the user device 1202a, 1202b, and/or 1202c and/or with the class of user device 1202a, 1202b, and/or 1202c. The class of the user device 1202a, 1202b, and/or 1202c can be related to a type of device, capability of device, type of service being provided, and/or a level of service. As an example, the service element 1212 can comprise information relating to or provided by a communication service provider (e.g., Internet service provider) that is providing or enabling data flow such as communication services to and/or between the user device 1202a, 1202b, and/or 1202c. As a further example, the service element 1212 can comprise information relating to a preferred service provider for one or more particular services relating to the user device 1202a, 1202b, and/or 1202c. In an aspect, the address element 1210 can be used to identify or retrieve data from the service element 1212, or vice versa. As a further example, one or more of the address element 1210 and the service element 1212 can be stored remotely from the user device 1202a, 1202b, and/or 1202c and retrieved by one or more devices such as the user device 1202a, 1202b, and/or 1202c and the computing device 1204. Other information can be represented by the service element 1212.

In an aspect, the computing device 1204 can be a server for communicating with the user device 1202a, 1202b, and/or 1202c. As an example, the computing device 1204 can communicate with the user device 1202a, 1202b, and/or 1202c for providing data and/or services. As an example, the computing device 1204 can provide services such as data sliming, data syncing, network (e.g., Internet) connectivity, network printing, media management (e.g., media server), content services, streaming services, broadband services, or other network-related services. In an aspect, the computing device 1204 can allow the user device 1202a, 1202b, and/or 1202c to interact with remote resources such as data, devices, and files. As an example, the computing device can be configured as (or disposed at) a central location, which can receive content (e.g., data) from multiple sources, for example, user devices 1202a, 1202b, and/or 1202c. The computing device 1204 can combine the content from the multiple sources and can distribute the content to user (e.g., subscriber) locations via a distribution system.

In an aspect, one or more network devices 1216 can be in communication with a network such as network 1220. As an example, one or more of the network devices 1216 can facilitate the connection of a device, such as user device 1202a, 1202b, and/or 1202c, to the network 1220. As a further example, one or more of the network devices 1216 can be configured as a wireless access point (WAP), In an aspect, one or more network devices 1216 can be configured to allow one or more wireless devices to connect to a wired and/or wireless network using Wi-Fi, Bluetooth or any desired method or standard.

In an aspect, the network devices 1216 can be configured as a local area network (LAN). As an example, one or more network devices 1216 can comprise a dual band wireless access point. As an example, the network devices 1216 can be configured with a first service set identifier (SSID) (e.g., associated with a user network or private network) to function as a local network for a particular user or users. As a further example, the network devices 1216 can be configured with a second service set identifier (SSID) (e.g., associated with a public/community network or a hidden network) to function as a secondary network or redundant network for connected communication devices.

In an aspect, one or more network devices 1216 can comprise an identifier 1218. As an example, one or more identifiers can be or relate to an Internet Protocol (IP) Address IPV4/IPV6 or a media access control address (MAC address) or the like. As a further example, one or more identifiers 1218 can be a unique identifier for facilitating communications on the physical network segment. In an aspect, each of the network devices 1216 can comprise a distinct identifier 1218. As an example, the identifiers 1218 can be associated with a physical location of the network devices 1216.

In an aspect, the computing device 1204 can manage the communication between the user device 1202a, 1202b, and/or 1202c and a database 1214 for sending and receiving data therebetween. As an example, the database 1214 can store a plurality of files (e.g., web pages), user identifiers or records, or other information, In one aspect, the database 1214 can store user device 1202a, 1202b, and/or 1202c usage information (including chronological usage), a status of a component of a device (e.g., coil failure), type of vaporizable and/or non-vaporizable material used, frequency of usage, location of usage, recommendations, communications (e.g., text messages, advertisements, photo messages), simultaneous use of multiple devices, and the like). The database 1214 can collect and store data to support cohesive use, wherein cohesive use is indicative of the use of a first electronic vapor devices and then a second electronic vapor device is synced chronologically and logically to provide the proper specific properties and amount of vapor based upon a designed usage cycle. As a further example, the user device 1202a, 1202b, and/or 1202c can request and/or retrieve a file from the database 1214. The user device 1202a, 1202b, and/or 1202c can thus sync locally stored data with more current data available from the database 1214. Such syncing can be set to occur automatically on a set time schedule, on demand, and/or in real-time. The computing device 1204 can be configured to control syncing functionality. For example, a user can select one or more of the user device 1202a, 1202b, and/or 1202c to never by synced, to be the master data source for syncing, and the like. Such functionality can be configured to be controlled by a master user and any other user authorized by the master user or agreement.

By way of example, usage information may include demographic information or other information about a user of the user device 1202a, 1202b, and/or 1202c. Demographic information can comprise one or more of a user's: age, gender, race, education level, location of residence, income, employment status, religion, marital status, property ownership, or known languages. The demographic information can be reported to the computing device 1204 if the user has opted in to having their usage activity tracked. For example, this information may be provided from the user device 1202a, 1202b, and/or 1202c to the computing device 1204 at opt-in time. The computing device 1204 may store the demographic information in the database 1214. In various embodiments, the demographic information may be associated with an identifier of the user for easy retrieval. For instance, all records for a specific user may be associated with a user's identifier. As the computing device 1204 stores the demographic information for later use, the demographic information need not be provided during vapor usage that occurs subsequent to the user's initial opt-in. Although it should be understood that the user of the user device 1202a, 1202b, and/or 1202c may provide updated demographic information at their discretion and/or at the request of the computing device 1204. In various embodiments, the demographic information may include but is not limited to information about a user's age, gender, education level, location of residence, income, employment status, religion, marital status, ownership (e.g., home, car, etc.), and known languages. This information may be utilized to generate reports for specific groups. in one non-limiting example, demographic information may be utilized to identify a group of users as young adults living in urban areas. For instance, a report generated for this group of users might specify the most popular vaporizable materials consumed by young adults living in urban areas. In an aspect, users may be tracked by a global identifier instead of personally identifiable information (e.g., the user's name). Thus the identifier can be known to the computing device 1204 but anonymous or otherwise unknown to other entities.

In an aspect, the computing device 1204 can generate recommendation data. The recommendation data can comprise a recommendation for a vaporizable material that a user has not used, a recommendation for a vaporizable material that a user has used, a recommendation for a mixture of two or more vaporizable materials that a user has not used, a recommendation for a mixture of two or more vaporizable materials that a user has used, a recommendation for a brand, a recommendation for a sale, a recommendation for a retailer, a recommendation for a manufacturer, a recommendation for an event, a recommendation for a social network, or a combination thereof. The central server can determine the recommendation data based on data received from at least one of a retailer, a manufacturer, an electronic device user, a vapor device user, a social network, or a combination thereof. The recommendation data can be generated in response to receiving usage data from the user device 1202a, 1202b, and/or 1202c and can be provided back to one or more of the user device 1202a, 1202b, and/or 1202c.

The computing device 1204 can utilize one or more recommendation systems/methods. For example, the computing device 1204 can utilize a non-personalized systems recommend products to individual consumers based on averaged information about the products provided by other consumers. Examples of non-personalized product recommendation systems are those of Amazon.com and Moviefinder.com. The same product recommendations are made to all consumers seeking information about a particular product(s) and all product recommendations are completely independent of any particular consumer.

The computing device 1204 can utilize an item-to-item systems recommend other products to an individual consumer based on relationships between products already purchased by the consumer or for which the consumer has expressed an interest. The relationships employed typically are brand identity, fragrance, sales appeal, market distribution, and the like. In all cases the information on which the relationships are based is implicit. In other words, no explicit input regarding what the consumer is looking for or prefers is solicited by these systems. Rather, techniques such as data mining are employed to find implicit relationships between products for which the individual consumer has expressed a preference and other products available for purchase. The actual performance of products or whether the consumer (or other consumers) ultimately did prefer the products purchased play no part in formulating recommendations with these types of systems.

The computing device 1204 can utilize an attribute-based recommendation systems utilize syntactic properties or descriptive “content” of available products to formulate their recommendations. In other words, attribute-based systems assume that the attributes of products are easily classified and that an individual consumer knows which classification he or she should purchase without help or input from the recommendation system.

The computing device 1204 can utilize a content-based filtering recommendation systems are based on a description of the item and a profile of the user's preference. In a content-based recommender system, keywords are used to describe the items and a user profile is built recommendation system indicate the type of item this user likes. In other words, these algorithms try to recommend items that are similar to those that a user liked in the past (or is examining in the present). In particular, various candidate items are compared with items previously rated by the user and the best-matching items are recommended.

The computing device 1204 can utilize a collaborative filtering (also referred to as social-information filtering) recommendation system that typically records an extended product preference set that can be matched with a collaborative group. In other words, collaborative filters recommend products that “similar users” have rated highly. Often the social-information is a similar pattern of product preferences.

In an aspect, data can be derived by system and/or device analysis. Such analysis can comprise at least by one of instant analysis performed by the user device 1202a, 1202b, and/or 1202c or archival data transmitted to a third party for analysis and returned to the user device 1202a, 1202b, and/or 1202c and/or computing device 1204. The result of either data analysis can be communicated to a user of the user device 1202a, 1202b, and/or 1202c to, for example, inform the user of their eVapor use and/or lifestyle options. In an aspect, a result can be transmitted back to at least one authorized user interface.

In an aspect, the database 1214 can store information relating to the user device 1202a, 1202b, and/or 1202c such as the address element 1210 and/or the service element 1212. As an example, the computing device 1204 can obtain the device identifier 1208a, 1208b, and/or 1208c from the user device 1202a, 1202b, and/or 1202e and retrieve information from the database 1214 such as the address element 1210 and/or the service elements 1212. As a further example, the computing device 1204 can obtain the address element 1210 from the user device 1202a, 1202b, and/or 1202c and can retrieve the service element 1212 from the database 1214, or vice versa. Any information can be stored in and retrieved from the database 1214. The database 1214 can be disposed remotely from the computing device 1204 and accessed via direct or indirect connection. The database 1214 can be integrated with the computing device 1204 or some other device or system. Data stored in the database 1214 can be stored anonymously and can be destroyed based on a transient data session reaching a session limit.

All the various data/information may be utilized by a report generator 1220 to generate reports for specific groups of users. In one example, the collected usage information, demographic information, and recommendation information can be associated with a user's identifier. The report generator 1220 can be configured for determining characteristics of a group. In various embodiments, these characteristics may be specified by a user desiring the report. In other cases, the characteristics may be parameters stored locally (e.g., on the computing device 1204 or another system). In various embodiments, such characteristics may include a specific demographic population. For instance, a non-limiting example of such characteristics might include all males between the ages of 18 and 32 living in the United States. Of course this is just one example of such characteristics. In general, any subset of demographic information may be specified as characteristics of a group. For instance, different advertisers may be interested in different types of groups for their products.

The report generator 1220 can be configured for defining a group as a subset of users having one or more of the characteristics. For instance, a user can search the database 1214 for all users that match the characteristics based on the demographic data collected (e.g., demographic data collected when the user opts-in to having their usage activities monitored/tracked). For instance, for the example above that specifies characteristics as being all males between the ages of 18 and 32 living in the United States, the report generator 1220 can search demographic information for users meeting these characteristics; the results list of users may be defined as the group for which a report is to be generated.

The report generator 1220 can be configured for generating a usage report based on collected usage information for users of the defined group. In various embodiments, the report may specify aggregate attributes for the group, such as what vaporizable material, what vapor device, what types of vaporizable material the group vaporizes most frequently, and the like. For instance, the report may specify a ranking of the most popular vaporizable materials consumed by users of the defined group. In other examples, the report may be more general in that types of vaporizable material (e.g., fruit flavored, menthol, nicotine, etc.) are ranked instead of specific vaporizable materials. As one non-limiting example, such a report might demonstrate that males between the ages of 18 and 32 living in the United States favor vaporizable material with nicotine over vaporizable material without, In general, the report may specific absolute and/or relative rankings for vaporizable material and/or types of vaporizable material, and any other rankable/measurable data point available in the usage data.

In various embodiments, the generated reports may be used by advertisers to select which vaporizable materials should be pursued for advertising. For instance, if an advertiser is targeting a demographic including males between the ages of 18 and 32 living in the United States, the advertiser could use the example report described above to target advertisements for specific products of interest to the group (including delivering an advertisement directly to the group's electronic vapor devices).

In an aspect, the computing device 1204 can comprise one or more modules for managing an eVapor Club 1220, The eVapor Club 1220 can be configured for conducting one or more financial transactions. For example, the eVapor Club 1220 can be configured to periodically debit one or more users' financial accounts for membership in the eVapor Club 1220 (including debiting at different amounts to account for different tiers of membership within the eVapor Club 1220). The eVapor Club 1220 can also be configured to debit one or more users' financial accounts for goods on as needed basis. The eVapor Club 1220 can be configured for analyzing one or more of usage data, demographic data, and user preferences to determine a good(s) to transfer to a user. Examples of user preferences include, but are not limited to, one or more of a tier of membership in an electronic vapor (eVapor) club, a time interval for periodic delivery of the good, a preferred retail location, a preferred delivery location. In one aspect, the eVapor Club 1220 can periodically initiate a transfer of a good to a user according to the user's tier of membership in the eVapor Club 1220 (e.g., cause a low, middle, or high quality vaporizable material to be mailed to the user or setup for pickup by the user at a retail location). The eVapor Club 1220 can select the good according to usage data e.g., is the user low on a particular vaporizable material) and recommendation data (e.g., what other flavor of vaporizable material might the user like) and user preferences (e.g., has the user indicated a preference for one or more types of vaporizable materials). In another aspect, the eVapor Club 1220 can analyze usage data to determine if the user's is in particular need for a specific good (e.g., a replacement component for the electronic vapor device).

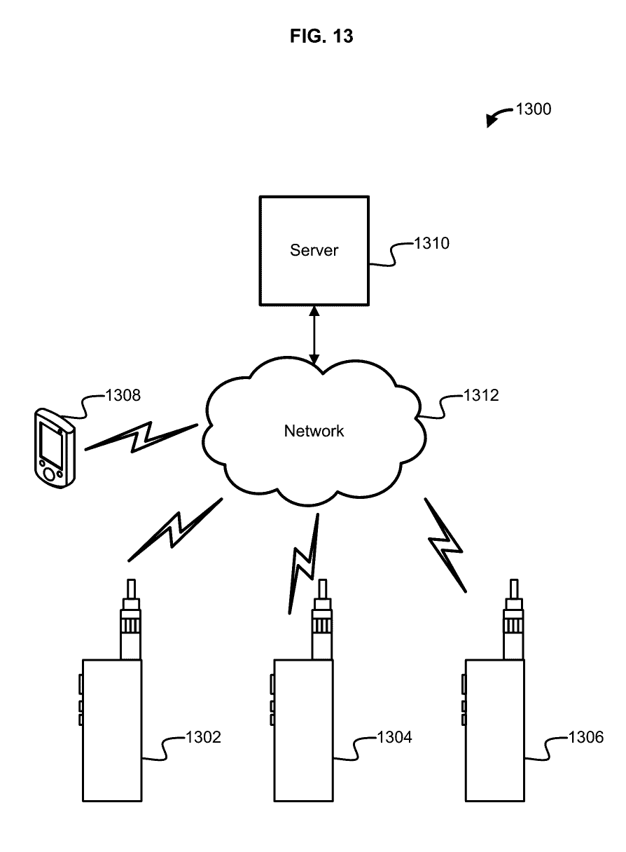

FIG. 13 illustrates an ecosystem 1300 configured for sharing and/or syncing data, and/or generating reports based on the data, such as usage information (including chronological usage), a status of a component of a device (e.g., coil failure), type of vaporizable and/or non-vaporizable material used, frequency of usage, location of usage, recommendation data, communications (e.g., text messages, advertisements, photo messages), simultaneous use of multiple devices, and the like) between one or more devices such as a vapor device 1302, a vapor device 1304, a vapor device 1306, and an electronic communication device 1308. In an aspect, the vapor device 1302, the vapor device 1304, the vapor device 1306 can be one or more of an e-cigarette, an e-cigar, an electronic vapor modified device, a hybrid electronic communication handset coupled/integrated vapor device, a micro-sized electronic vapor device, or a robotic vapor device. In an aspect, the electronic communication device 1308 can comprise one or more of a smartphone, a smart watch, a tablet, a laptop, and the like.

In an aspect data generated, gathered, created, etc., by one or more of the vapor device 1302, the vapor device 1304, the vapor device 1306, and/or the electronic communication device 1308 can be uploaded to and/or downloaded from a central server 1310 via a network 1312, such as the Internet. Such uploading and/or downloading can be performed via any form of communication including wired and/or wireless. In an aspect, the vapor device 1302, the vapor device 1304, the vapor device 1306, and/or the electronic communication device 1308 can be configured to communicate via cellular communication, WiFi communication, Bluetooth® communication, satellite communication, and the like. The central server 1310 can store uploaded data and associate the uploaded data with a user and/or device that uploaded the data. The central server 1310 can access unified account and tracking information to determine devices that are associated with each other, for example devices that are owned/used by the same user. The central server 1310 can utilize the unified account and tracking information to determine which of the vapor device 1302, the vapor device 1304, the vapor device 1306, and/or the electronic communication device 1308, if any, should receive data uploaded to the central server 1310. In an aspect, the central server 1310 can be configured to operate as an eVapor Club as described herein.

In an aspect, the uploading and downloading can be performed anonymously. The data can be shared over a transient data session with the central server 1310, The transient data session can comprise a session limit. The session limit can be based on one or more of a number of puffs, a time limit, and a total quantity of vaporizable material. The data can comprise usage data and/or a usage profile. The central server 1310 can destroy the data once the session limit is reached. While the transient data session is active, the central server 1310 can provide a usage profile to one of the vapor device 1302, the vapor device 1304, the vapor device 1306 to control the functionality for the duration of the transient data session.

For example, the vapor device 1302 can be configured to upload usage information related to vaporizable material consumed and the electronic communication device 1308 can be configured to upload location information related to location of the vapor device 1302. The central server 1310 can receive both the usage information and the location information, access the unified account and tracking information to determine that both the vapor device 1302 and the electronic communication device 1308 are associated with the same user. The central server 1310 can thus correlate the user's location along with the type, amount, and/or timing of usage of the vaporizable material. The central server 1310 can further determine which of the other devices are permitted to receive such information and transmit the information based on the determined permissions. In an aspect, the central server 1310 can transmit the correlated information to the electronic communication device 1308 which can then subsequently use the correlated information to recommend a specific type of vaporizable material to the user when the user is located in the same geographic position indicated by the location information.

In an aspect, one or more of the vapor device 1302, the vapor device 1304, and/or the vapor device 1306 can provide the respective users with an option to have usage activity tracked (e.g., upload usage data to the central server 1310). For example, if a user opts in to having usage activity tracked, the user can also provide demographic information about the user to the central server 1310. Demographic information can comprise one or more of a user's: age, gender, race, education level, location of residence, income, employment status, religion, marital status, property ownership, or known languages. The collected demographic information and the usage data can be utilized to generate one or more usage reports representing usage across one or more of the users of the vapor device 1302, the vapor device 1304, and/or the vapor device 1306.

In another aspect, the central server 1310 can provide one or more social networking services for users of the vapor device 1302, the vapor device 1304, the vapor device 1306, and/or the electronic communication device 1308. Such social networking services include, but are not limited to, messaging (e.g., text, image, and/or video), mixture sharing, product recommendations, location sharing, product ordering, and the like.

In an aspect, the vapor device 1302, the vapor device 1304, and/or the vapor device 1306 can be in communication with the electronic communication device 1308 to enable the electronic communication device 1308 to generate a user interface to display information about and to control one or more functions/features of the vapor device 1302, the vapor device 1304, and/or the vapor device 1306. The electronic communication device 1308 can request access to one or more of the vapor device 1302, the vapor device 1304, and/or the vapor device 1306 from the central server 1310. The central server 1310 can determine whether or not the electronic communication device 1308 (or a user thereof) is authorized to access the one or more of the vapor device 1302, the vapor device 1304, and/or the vapor device 1306. If the central server 1310 determines that access should be granted, the central server 1310 can provide an authorization token to the electronic communication device 1308 (or to the vapor device 1302, the vapor device 1304, and/or the vapor device 1306 on behalf of the electronic communication device 1308). Upon receipt of the authorization token, the one or more of the vapor device 1302, the vapor device 1304, and/or the vapor device 1306 can partake in a communication session with the electronic communication device 1308 whereby the electronic communication device 1308 generates a user interface that controls one or more functions/features of and displays information about the one or more of the vapor device 1302, the vapor device 1304, and/or the vapor device 1306.

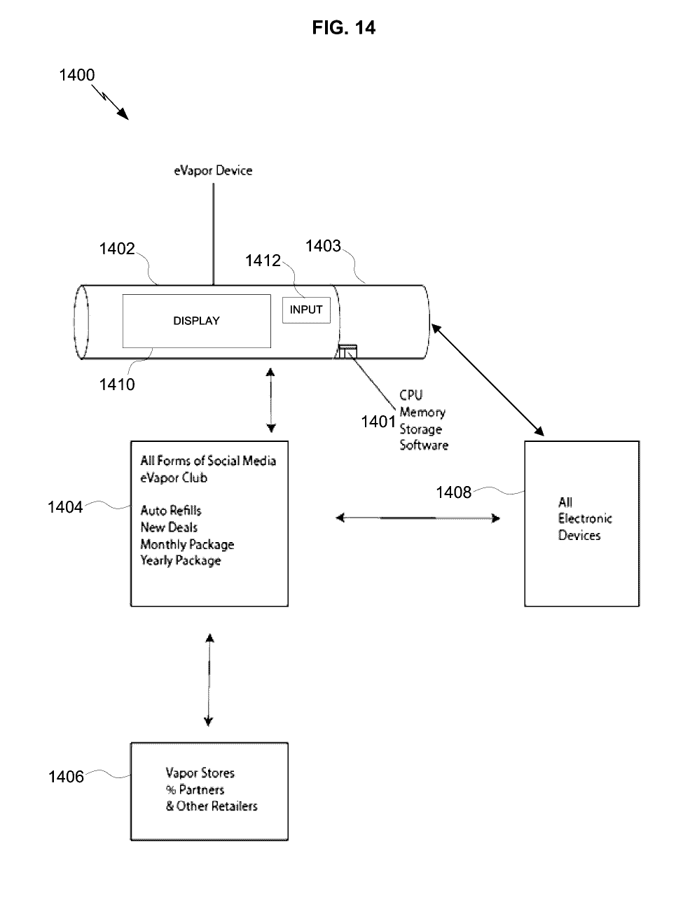

FIG. 14 illustrates a system 1400 for providing an e-vapor club to one or more electronic vapor devices (or personal vaporizers, or devices) 1402, 1408. The e-vapor club can also be accessed by other electronic devices such as a smartphone, a tablet, a laptop, or the like. The system 1400 can include a server 1404, such as an app server, for providing a user interface to the one or more devices 1402, 1408. The user interface may be a generic user interface usable by each of the one or more devices 1402, 1408 to interact with the e-vapor club or can be specifically tailored to each of the devices 1402, 1408 based on the capabilities of each device. The e-vapor club can provide a variety of features such as an online social gathering place, may generate and transmit directed advertisements to each of the devices 1402, 1408, and may allow a user to register for services, such as new and/or repeated sales of vapor devices or accessories to the user at periodic or non-periodic intervals.

For example, the server 1.404 can provide a user interface to the electronic vapor device 1402 to be displayed on a display 1410 of the device 1402. The interface may initially display an advertisement to the club. If a user of the device 1402 joins the club, he or she may register for one or more various services. For example, one service may include periodically tendering a preferred vaporizable material to the user. Another service may include periodically tendering a new vaporizable material to the user. This service may use data collected by the server 1404 to select each new vaporizable material. In yet other aspects, the e-vapor club can provide offers to the user of the e-vapor device that are determined based on data collected by the server 1404.

The e-vapor club may also provide an online gathering place for socializing and discussing vaporizer-related matters. For example, the e-vapor club may provide a message board on which any member can post a subject. The e-vapor club may include additional features such as allowing one member to see the location of another member of the e-vapor club.

The server 1404 may also use the e-vapor club to collect data regarding the user. For example, the device may include an input 1412 for receiving user input. As a user receives goods from the e-vapor club, the user may provide a rating for the goods using the input 1412 to be received by the server 1404. Similarly, the device 1402 may include a feature for detecting what type of vaporizable material is being used by the device 1402 and may transmit this data to the server 1404. The server 1404 may also collect social data posted or sent to the e-vapor club, such as chats or message board conversations in which the user participated.

The server 1406 may be in operative communication with one or more stores 1406 that provide vapor-related goods, services, or the like. The server 1406 may communicate with the store 1406 such as to provide collected data regarding a user, to request shipment of selected goods to the user, or the like. In some aspects, the server 1404 may also communicate with various stores 1406 near the device 1402 and instruct a user of the device 1402 to go to a nearby store that has the desired product in stock.

The device 1402 is configured to vaporize or nebulize a vaporizable or nebulizable material. The device 1402 includes an outer casing 1403. The device 1402 can comprise any suitable component for providing vapor to a user. Generally, the device 1402 is an electronic device for use in providing a vapor output and typically includes a processor 1401. The outer casing 1403 may be designed to resemble at least one of a cigarette, a cigar, a hookah, a bowl, a bong, a pipe, a water pipe, a one hitter, a joint, a blunt, a chillum or a steamroller. In some embodiments, the outer casing 1403 may be designed to resemble a wearable or other item such as a pendant, jewelry, a watch, an accessory or headphones. The device 1400 may also include a heating element (such as a vaporizer, not shown) coupled to one or more containers (not shown).

When the vaporizer is activated, it may vaporize or nebulize a vaporizable or non-vaporizable material held within the containers. The vapor may then be allowed to pass through an outlet (not shown) defined by the outer casing 1403 as suction is applied at the outlet.

The input 1412 may include any input device such as a button, a knob, a keyboard, a touchscreen, a microphone, a camera (for detecting hand movement) or the like. In some embodiments, the input 1412 can be external and coupled to the device 1400, such as a smartphone wirelessly coupled to the device 1400. The input 1412 may be coupled to the processor 1401 such that data received by the input 1412 is also received by the processor 1401. The display 1410 can include any output device such as a display or other output device, such as a touchscreen, a speaker, one or more light emitting elements, or the like some embodiments, the display 1410 may be external to the device 1402, such as a plug-in display, a display of a remote device (such as a smartphone) or the like. The display 1410 may be coupled to the processor 1401 and may output data as instructed by the processor 1401.

In some embodiments, other devices 1408 may include an output device different than the display 1410 and a processor adapted to convert received output data to properly be output by the output device. For example, output data provided by the server 1404 may include a GUI; however, some devices 1408 may not include a display for outputting the GUI. The processor of the corresponding device may be adapted to, for example, convert the GUI into audio output data and cause the audio data to be output by a speaker of the device 1408. In some embodiments, the server 1404 may receive data indicating capabilities of the other devices 1408, such as types of input and output devices, and transmit corresponding output data to each of the devices 1402, 1408.

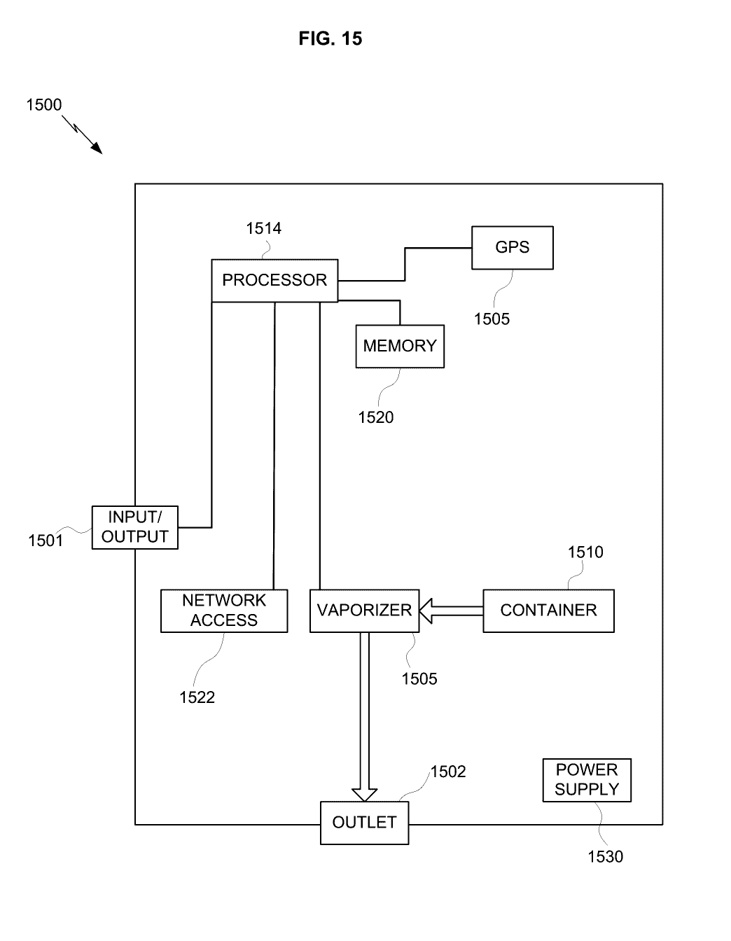

With reference now to FIG. 15, a device 1500 may include a vaporizer 1505. The vaporizer 1505 may be coupled to one or more containers 1510. Each of the one or more containers 1510 may be configured to hold one or more vaporizable materials. The vaporizer 1505 may receive the vaporizable or non-vaporizable material from the one or more containers 1510 and heat the materials until they achieve a vapor state. In various embodiments, instead of heating the material, the vaporizer 1505 may nebulize or otherwise cause the material of the containers 1510 to reduce in size into particulates. In various embodiments, the container 1510 may include a compressed liquid that is released to the vaporizer 1505 via a valve or another mechanism. In various embodiments, the container may include a wick (not shown) through which the material is drawn to the vaporizer 1505. The container 1510 may be made of any suitable structural material, such as, an organic polymer, metal, ceramic, composite, or glass material.

The processor 1514 may be, or may include, any suitable microprocessor or microcontroller, for example, a low-power application-specific controller (ASIC) and/or a field programmable gate array (FPGA) designed or programmed specifically for the task of controlling a device as described herein, or (less preferably) a general purpose central processing unit (CPU), for example, one based on 80×86 architecture as designed by Intel™ or AMD™, or a system-on-a-chip as designed by ARM™. The processor 1514 may be communicatively coupled to auxiliary devices or modules of the personal vaporizer 1500 using a bus or other coupling.

The device 1500 may include a memory device 1520 operatively coupled to the processor 1514. The memory device 1520 may include a random access memory (RAM) holding program instructions and data for rapid execution or processing by the processor 1514 during control of the device 1500. When the device 1500 is powered off or in an inactive state, program instructions and data may be stored in a long-term memory, for example, a non-volatile magnetic optical, or electronic memory storage device not shown). Either or both of the RAM or the storage device may comprise a non-transitory computer-readable medium holding program instructions that, when executed by the processor 1514, cause the device 1500 to perform a method or operations described herein. Program instructions may be written in any suitable high-level language, for example, C, C++, C# or the Java™, and compiled to produce machine-language code for execution by the processor 1514.

The device 1500 may include a network access device 1522 allowing the device 1500 to be communicatively coupled to one or more ancillary devices (not shown) such as via an access point (not shown) of a wireless telephone network, local area network, or other coupling to a wide area network, for example, the Internet. In that regard, the processor 1514 may share data with the ancillary device via the network access device 1522. The shared data may include usage data or operational data of the device 1500, the status of the device 1500, the status or operating condition of each of the components of the device 1500, text to be used in a message, a product order, payment information or any other data. Similarly, the processor 1514 may receive control instructions from the ancillary device via the network access device 1522. For example, a configuration of the device 1500, operation of the device 1500, or other settings of the device 1500, may be controlled by the ancillary device via the network access device 1522. For example, one ancillary device may include a server that provides an e-vapor club and another ancillary device may include a smartphone for controlling operation of the device 1500. In some embodiments, the smartphone or another ancillary device may be used as the primary input/output of the device 1500 such that data is received by the device 1500 from the server, transmitted to the smartphone and output on a display of the smartphone.

The device 1500 may also include an input/output device 1501 coupled to one or more of the processor 1514, the vaporizer 1505, the network access 1522, and/or any other electronic component of the device 1500. Input may be received from a user or another device and/or output may be provided to a user or another device via the input/output device 1501. The input/output device 1501 may include any combinations of input and/or output devices such as buttons, knobs, keyboards, touchscreens, displays, light-emitting elements, a speaker, or the like. The input/output device 1501 may also or instead comprise an interface port such as a wired interface, for example a serial port (not shown) such as a Universal Serial Bus (USB) port, an Ethernet port, or other suitable wired connection. The input/output device 1501 may comprise a wireless interface, for example a transceiver (not shown) using any suitable wireless protocol, for example Wifi (IEEE 802.11), Bluetooth™, infrared, or other wireless standard. For example, the input/output device 1501 can communicate with a smartphone via Bluetooth™ such that the inputs and outputs of the smartphone can be used by the user to interface with the device 1500.

Input from the input/output device 1501 may be use by the processor 1514 to the vaporizer 1505 vaporize the vaporizable material. For example, a user may depress a button, causing the vaporizer 1505 to start vaporizing material. A user may then draw on the outlet 1502 to inhale the vapor. In various embodiments, the processor 1514 may control vapor production and flow to the outlet 1502 based on data detected by a flow sensor (not shown). For example, as a user draws on the outlet 1502, the flow sensor 1509 may detect this pressure. In response, the processor 1514 may cause the vaporizer 1505 to begin vaporizing material.

The input/output device 1501 may be used to receive or output data corresponding to an e-vapor club. For example, a user may use the input/output device 1501 to communicate with other users in a message board, a user may use the input/output device 1501 to provide his preferences to the club, a user may use the input/output device 1501 to order specific products, or the like. In some embodiments, the user may provide a delivery address to the e-vapor club via the input/output device 1501.

The device 1500 may also include a global positioning system (UPS) unit 1505. The

UPS 1505 may detect a current location of the device 1500. In some embodiments, a user may request a delivery to his/her current location such that the e-vapor club can determine the user's location via the UPS 1505. For example, the processor 1514 may receive location data from the GPS 1505, convert it to usable data, and transmit it to the e-vapor club via the network access device 1522. In some embodiments, the user may wish to find a nearby store that sells a particular product and may request this information from the e-vapor club. The processor 1514 may again receive location data from the UPS 1505 and transmit the data, along with the request, to the e-vapor club.

The device 1500 may also include a power supply 1530. The power supply 1530 may include a battery or other storage device and/or a port for connecting to an external power supply. For example, an external power supply may supply power to the device 1500 and a battery may store at least some of the supplied power.

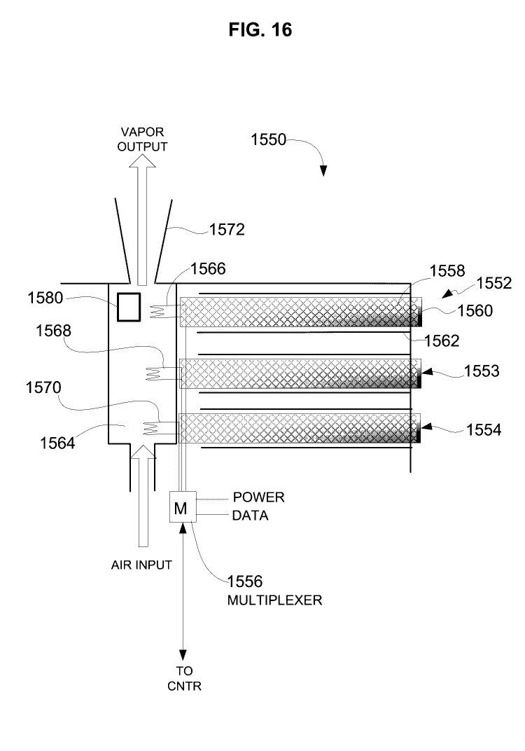

With reference now to FIG. 15 and FIG. 16, another exemplary vaporizer 1550 is shown. The vaporizer 1550 may be used internally of the device 1500 or may be a separate device. For example, the vapor device 1550 may be used in place of the vaporizer 1505. The vaporizer 1550 illustrates various aspects of using a personal vaporizer.

The vaporizer 1550 may include or be coupled to one or more containers 1560 containing a vaporizable material, for example a fluid. For example, coupling may be via a wick 1558, via a valve, or by some other structure. The coupling mechanism may operate independently of gravity, such as by capillary action or pressure drop through a valve. The vaporizer 1550 may be configured to vaporize the vaporizable material from one or more containers 1560 at controlled rates, in response to mechanical input from a component of the device 1500, and/or in response to control signals from the processor 1514 or another component. Vaporizable material (e.g., fluid) may be supplied by replaceable cartridges 1552, 1553, 1554. Each of the cartridges 1552, 1553, 1554 may include a container 1560 for a vaporizable material. If material is liquid, the cartridge may include a wick 1558 to aid in transporting the liquid to the vaporizing element 1566. In the alternative, some other transport mode may be used. Each of the cartridges 1552, 1553, 1554 may be configured to fit inside and engage removably with a receptacle (such as the container 1510 and/or the secondary container 1512) of the device 1500. In an alternative, or in addition, one or more fluid containers 1560 may be fixed in the device 1500 and configured to be refillable. In that regard, one or more materials may be vaporized at a single time by the vaporizer 1550. For example, some material may be vaporized and drawn through the outlet 1502 and/or some material may be vaporized and exhausted via the smoke simulator outlet 1504.

In operation, a heating element 1580 may vaporize or nebulize the vaporizable material in a mixing chamber 1564, producing an inhalable mist that is expelled via an exhaust port 1572, in embodiments, the heating element 1580 may include a heater coupled to a wick (or a heated wick) 1566, 1568, 1570 operatively coupled to (for example, in fluid communication with) the mixing chamber 1564, The heating element 1580 may include a nickel-chromium wire or the like, with a temperature sensor (not shown) such as a thermistor or thermocouple. Within definable limits, by controlling power to each of the heated wicks 1564, 1568, 1570, a rate of vaporization may be independently controlled at each wick. A multiplexer 1556 may receive power (P) from any suitable source and exchange data signals (D) with the processor 1514 for control of the vaporizers. At minimum, control may be provided between no power (off state) and one or more powered states. Other control mechanisms may also be suitable.

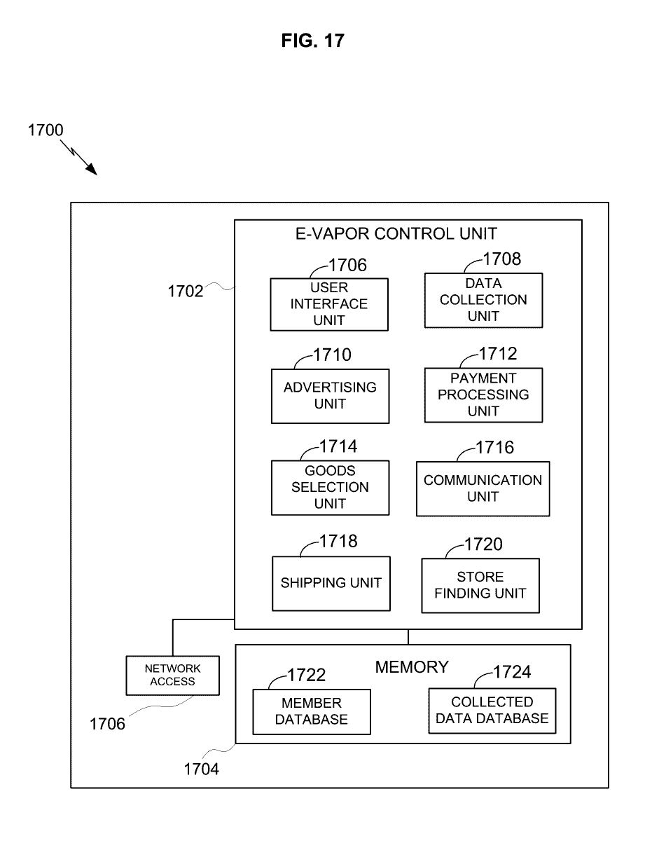

Turning FIG. 17, an e-vapor club server, or server, 1700 illustrates various aspects of providing an e-vapor club to users of vaporizer devices. The server 1700 includes an e-vapor control unit 1702 for providing the e-vapor club services. The e-vapor control unit may include any suitable microprocessor or microcontroller, for example, a high-power application-specific controller (ASIC) and/or a field programmable gate array (FPGA) designed or programmed specifically for the task of providing an e-vapor club to various vaporizer devices, or a general purpose central processing unit (CPU), for example, one based on 80×86 architecture as designed by Intel™ or AMD™ or a system-on-a-chip as designed by ARM™. The e-vapor control unit 1702 may be communicatively coupled to auxiliary devices or modules of the personal vaporizer 1500 using a bus or other coupling.

The server 1700 may include a memory device 1704 operatively coupled to the e-vapor control unit 1702. The memory device 1704 may include a random access memory (RAM) holding program instructions and data for rapid execution or processing by the e-vapor control unit 1702 during control of the server 1700. When the server 1700 is powered off or in an inactive state, program instructions and data may be stored in a long-term memory, for example, a non-volatile magnetic optical, or electronic memory storage device (not shown). Either or both of the RAM or the storage device may comprise a non-transitory computer-readable medium holding program instructions that, when executed by the e-vapor control unit 1702, cause the server 1700 to perform a method or operations described herein.

Program instructions may be written in any suitable high-level language, for example, C++, C# or the Java™, and compiled to produce machine-language code for execution by the e-vapor control unit 1702.

The server 1700 may also include a network access device 1706 for allowing the server 1700 to be communicatively coupled to one or more devices (not shown) such as via an access point (not shown) of a wireless telephone network, local area network, or other coupling to a wide area network, for example, the Internet. In some embodiments, the network access device 1706 may be capable of high data transfer such as one or more Gigabit Ethernet ports, a port for transferring data via fiber-optic cables or the like. In that regard, the e-vapor control unit 1702 may share data with the ancillary device via the network access device 1706. The shared data may be associated with an e-vapor club service such as chat or message communications, offers to join the club, offers for particular products, or the like. The products can include one or more of a new electronic vapor device, a battery, an atomizer, a replaceable coil, wick material, another component for the electronic vapor device, an accessory for the electronic vapor device, or the like.

The e-vapor control unit 1702 can include a number of sub-units (also referred to as units) such as a user interface unit 1706, a data collection unit 1708, an advertising unit 1710, a payment processing unit 1712, a goods selection unit 1714, a billing unit 1716, a shipping unit 1718 and/or a store finding unit 1720. The sub-units may all be part of a single system or device, may each comprise a separate system or device, or some sub-units can be part of a single system or device and other sub-units can comprise a separate system or device. The sub-units may perform operations as stored in the memory 1704 and/or may be hardware designed to perform the functions, such as an ASIC. Additionally, the e-vapor control unit 1702 may include greater or fewer sub-units than shown, and some or all of the sub-units may be combined.

The user interface unit 1706 may provide a user interface to one or more personal vaporizers/electronic vapor devices. For example, the user interface unit 1706 may generate a GUI that is provided to the electronic vapor device and displayed on a display of the electronic vapor device. The user interface unit 1706 may also provide other interfaces such as text only, audio only, or any other interface for communicating with the electronic vapor device. For example, the user interface unit 1706 may include a text based user interface so that a user of an electronic vapor device can send a text instruction to the server 1700 and receive text feedback from the server 1700. The user interface unit 1706 may provide a standard interface to each connected device, may provide an individualized interface to each device based on the capabilities of the device, or any combination of standard and individualized interfaces.

The server 1700 may receive data from each connected device via the network access device 1706. The data may be collected and stored by the data collection unit 1708. For example, a user may purchase goods from the e-vapor club using his electronic vapor device. A user may also communicate with other users of the e-vapor club using private messaging, a message board, or the like. The personal vaporizer of the user may also be able to detect types usage information, such as types of vaporizable material used, how often the device is used, a quantity of vaporizable material used per day, location data corresponding to locations of the device (such as via a GPS), or the like, and transfer this data to the server 1700. A user may also provide preference data to the e-vapor club including likes and dislikes of particular products, particular types of products, particular flavors, or the like. Any of this data may be stored by the data collection unit 1708 in the memory 1704.

The memory 1704 may include a collected data database 1724 accessible by the e-vapor control unit 1702 such that the data collection unit 1708 can store and access data within the collected data database.

The advertising unit 1710 may determine advertisements and/or offers to send to a user based on the data collected regarding the user and/or other users of electronic vapor devices. For example, the collected data database 1724 may include data corresponding to favorite vaporizable materials of the user. The advertising unit 1710 may use this data to direct data including an advertisement of the favorite vaporizable material to the device of the user.

The e-vapor control unit 1702 may also analyze data corresponding to a plurality of users to determine group behavior. For example, if most users like a particular atomizer, the advertising unit 1710 may advertise that atomizer to one or more customers who have not yet purchased the atomizer.

In some embodiments, the e-vapor club provided by the server 1700 may allow users to register for one or more services. For example, a service may include periodically charging for and tendering a product to a user. The product may be a requested product that does not change between periods and/or may include a new product each period.

Services may also vary based on the quality of the products tendered, the frequency of tendering the products, the number of products provided, or any other factors. The memory 1704 may include a member database 1722 that stored each member and their corresponding service. The member database 1722 may also store additional data such as a delivery address, a preferred delivery type, a payment method, any products that are undesirable to the user, how long the user has been a member for, or the like. For example, one service may be a vaporizable material service and provide goods of a first price at a first periodic interval, another service may be another vaporizable material service and provide goods of a different price than the first price and a different periodic interval, and yet another service may be for periodic delivery of replacement coils

The advertising unit 1710 may also access the member database 1722 when generating advertisements and/or offers. For example, some offers may be available for long-term club members that are not available for newer members, and the advertising unit 1710 may obtain this data from the member database 1722 to provide the offer to the qualifying members. In some embodiments, the e-vapor control unit 1702 may transmit data from one or more of the member database 1722 or the collected data database 1724 to other entities, such as a seller of goods, an advertising firm, or the like.

The advertising unit 1710 may also generate customized advertisements for e-vapor club membership. For example, if a user likes a particular line of products, the advertising unit 1710 may generate a membership advertisement that includes a reference to products associated with the club from the particular line of products.

A user who is not yet a member may still be able to purchase goods from the e-vapor club without joining the club. For example, the advertising unit 1710 may transmit an advertisement for a particular product that the user desires. The user may then request to purchase this product from the e-vapor club. In that regard, the advertising unit 1710 may be capable of transmitting one or more of a one-time purchase offer, content, an offer to subscribe to a periodic subscription purchase package, a recommendation, an advertisement, advice or guidance.

The payment processing unit 1712 may be capable of billing and/or collecting payment from membership and/or individual purchases. For example, membership of a particular service may have a predetermined monthly cost. The payment processing unit 1712 may access the member database 1722 to determine the type of service that the member has and determine the price based on the type of service. Additionally, a cost may be associated with each product offered by the e-vapor club. The payment processing unit 1712 may access the memory 1704 to determine the cost for any purchased product.

After determining a payment amount, the payment processing unit 1712 may determine whether to bill or to charge immediately for the service or product. For example, some users may prefer to receive a bill for membership or products. This information may be stored in the member database 1722 and accessed by the payment processing unit 1712. The payment processing unit 1712 may then create a bill for the total amount due. In some embodiments, the e-vapor control unit 1702 may be in communication with a printer and cause the bill to be printed and/or may email the bill to the customer/member. Returning to user preferences, some users may prefer to immediately pay for membership/goods using a credit card, a debit card, an account number, or the like. The payment processing unit 1712 may first access the member database 1722 to determine if any payment methods are provided in the member database 1722, The payment processing unit 1712 may then request verification of the payment method from the user. If no payment methods are provided in the member database 1722, the payment processing unit 1712 may request payment information from the user. After the stored or received payment method has been verified by the user, the e-vapor control unit 1702 may communicate with another server to bill the payment method. in some embodiments, the payment processing unit 1712 may instruct the e-vapor control unit 1702 to continue with the tender of the goods after payment has been completed.

The goods selection unit 1714 may use data from the member database 1722 and/or the collected data database 1724 to determine which goods to tender to the members of the random product service, For example, if a user prefers sweet flavored vaporizable material, the goods selection unit may receive that preference from the collected data database 1724 and select a sweet flavored vaporizable material to send to the user. The goods selection unit 1714 may select goods to send to tender in a similar manner as the advertising unit 1710 determines advertisements to transmit. In this way, products can be selected for each user based on their data profile in the collected data database 1724.

The communication unit 1716 allows users to communicate with each other. The communication unit 1716 may host message boards, allow private messaging, or the like. For example, a message board may include forums for a plurality of various products. In some embodiments, the communication unit 1716 allows a first user to view the purchase history, ratings and/or reviews of goods of another user. In these embodiments, the advertising unit 1710 may advertise certain promotions such as a promotion allowing a user to receive an incentive if one or more users purchase a product based on the first user's purchase history, review and/or rating.

The member database 1722 may store delivery preferences for each member, Some members may prefer for a delivery to their address, some may prefer a delivery to a current location of the member, and some may prefer to pick up the product from a local store. In that regard, the shipping unit 1718 and the store finding unit 1720 may communicate with the member database 1722 to tender the product to the member.

For example, a member may desire to have the goods shipped to his address. The shipping unit 1718 may receive the preference and address from the member database 1722 and cause the product to be shipped to the address by, for example, printing a shipping label, transmitting a shipping request to another device, adding a scheduling event, or the like.

The shipping unit 1718 may also receive a current location of a member's device and arrange to have the product delivered to the current location of the member. For example, the shipping unit 1718 may access the store finding unit 1720 to determine a store that is near the current location of the user and includes the desired product. The shipping unit 1718 may also find a delivery provider to transport the good from the store to the user. In some embodiments, the product may be delivered from a warehouse and/or may include dedicated delivery personnel. In some embodiments, some stores may include their own delivery personnel and the shipping unit 1718 may also find a store near the user who has the product and is able and willing to deliver the product to the user's current location.

Some users may prefer to pick up the product from the store directly. The store finding unit 1720 may determine one or more stores close to the user's current location that include the product. The user may then be able to select a desired store and receive an address and/or navigation instructions from the server 1700.

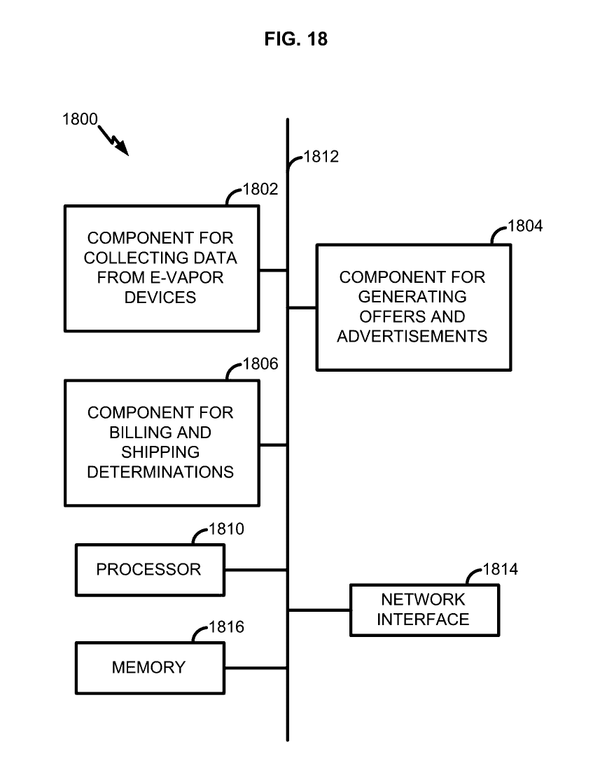

FIG. 18 is a block diagram illustrating components of an apparatus or system 1800 for providing an e-vapor club to personal vaporizers, in accord with the foregoing examples. The apparatus or system 1800 may include additional or more detailed components as described herein. For example, the processor 1810 and memory 1816 may contain an instantiation of a controller for a device as described herein. As depicted, the apparatus or system 1800 may include functional blocks that can represent functions implemented by a processor, software, or combination thereof (e.g., firmware).

As illustrated in FIG. 18, the apparatus or system 1800 may comprise an electrical component 1802 for collecting data from electronic vapor devices. For example, the component may include an e-vapor control unit, a processor, or other controller, The component 1802 may be, or may include, a means for collecting the data. Said means may include the processor 1810 coupled to the memory 1816, and to the network interface 1814, the processor executing an algorithm based on program instructions stored in the memory. Such algorithm may include a sequence of more detailed operations pertaining to collecting data as described herein.

The apparatus or system 1800 may further comprise an electrical component 1804 for generating offers and advertisements. For example, the component 1804 may include an e-vapor control unit or another processor or controller. The component 1804 may be, or may include, a means for generating the offers and advertisements. Said means may include the processor 1810 coupled to the memory 1816 and to the network interface 1814, the processor executing an algorithm based on program instructions stored in the memory 1816. Such algorithm may include a sequence of more detailed operations pertaining to generating offers and ads, for example, as described in connection with any of the methods described herein.

The apparatus or system 1800 may further comprise an electrical component 1806 for billing and shipping determinations by the apparatus or system 1800. For example, the component 1806 may include a means for determining billing and shipping information. Said means may include the processor 1810 coupled to the memory 1816, and to the network interface 1814, the processor executing an algorithm based on program instructions stored in the memory, Such algorithm may include a sequence of more detailed operations pertaining to billing and shipping, for example, as described in connection with any of the methods described herein.

The apparatus 1800 may include a processor module 1810 having at least one processor, in the case of the apparatus 1800 configured as an e-vapor control unit for providing an e-vapor club. The processor 1810, in such case, may be in operative communication with the memory 1816, interface 1814, and/or components 1802, 1804, 1806 via a bus 1822 or similar communication coupling. The processor 1810 may effect initiation and scheduling of the processes or functions performed by electrical components 1802-1806.

In related aspects, the apparatus 1800 may include a network interface module 1814 operable for communicating with an e-vapor device over a computer network. In further related aspects, the apparatus 1800 may optionally include a module for storing information, such as, for example, a memory device/module 1816. The computer readable medium or the memory module 1816 may be operatively coupled to the other components of the apparatus 1800 via the bus 1822 or the like. The memory module 1816 may be adapted to store computer readable instructions and data for enabling the processes and behavior of the modules 1802-1806, and subcomponents thereof, or of the methods disclosed herein. The memory module 1816 may retain instructions for executing functions associated with the modules 1802-1806. While shown as being external to the memory 1816, it is to be understood that the modules 1802-1806 can exist within the memory 1816.

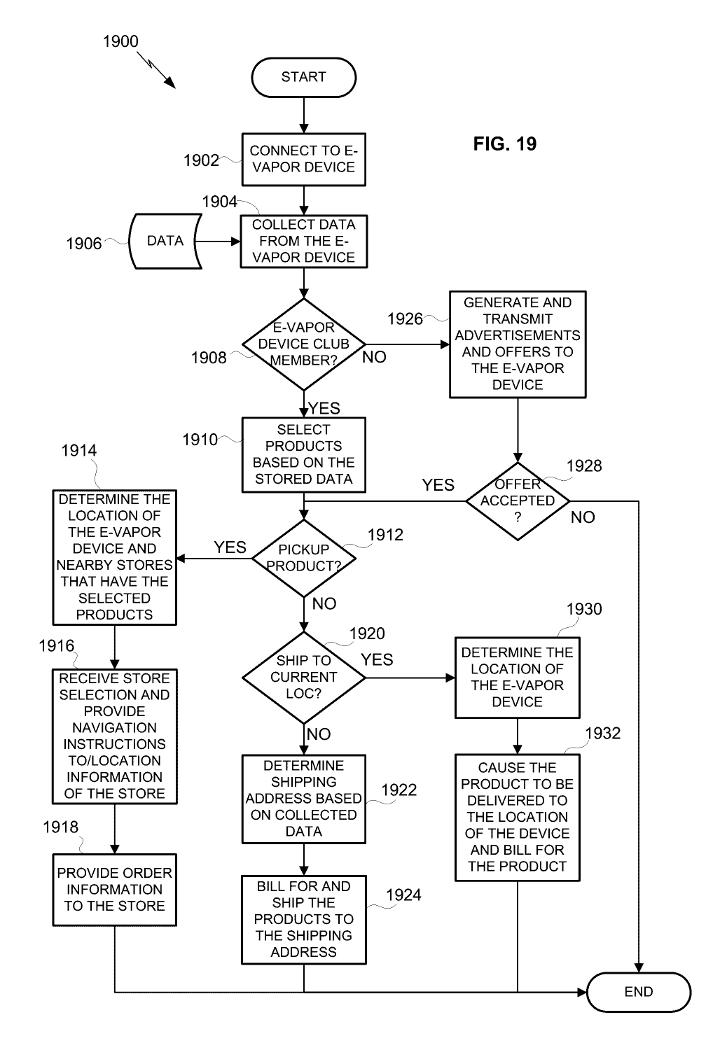

With reference now to FIG. 19, aspects of a method 1900 for use by an e-vapor control unit of a server for providing an e-vapor club is illustrated.

At 1902, the server may connect to an electronic vapor device (e-vapor device, device). The connection may be via one or more network access devices.

At 1904, the server may receive, store and organize data 1906 from the e-vapor device.

At 1908, the processor may determine whether the e-vapor device is associated with a member of the e-vapor club. For example, a known hardware address of the device may be associated with a membership, a user may enter a login and password (or other security identifier, such as a biometric) into the device. If the device is associated with a member, the server may select products to tender to the device based on the stored data 1906.

At 1912, the server may determine whether the member will pick up the product or have it delivered. If the user is to pick up the product, the server may determine the location of the e-vapor device and stores nearby the e-vapor device that have the desired product in stock at 1914. The server may also provide the name, location, distance, other information corresponding to the one or more stores having the product in stock to the user.

At 1916, the server may receive the selection of a desired store from the user. The server may also provide location information such as an address, navigation instructions, or other location information to the e-vapor device.

At 1918, the server may transmit an order for the product to the selected store. For example, the order may be electronic or via another method, such as an automated phone call. In some embodiments, the order may include payment information, a credit to the store for the tendered product, or the like.

If the user prefers to have the good delivered, the server may determine, at 1920, whether the user wants to have the product shipped to his current location or another address. If the location is another address, the server may determine the shipping address based on collected and/or stored data, For example, the data 1906 may include a preferred address and/or the user may provide an address to the server at this time.

At 1924, the server may bill for the product and cause the product to be shipped to the selected address.

At 1926, if the user is not a member of the e-vapor club, the server may generate and transmit advertisements and/or offers to the e-vapor device. The offer may include an offer to join the club, an offer to purchase products, or the like.

At 1928, the server may determine whether the offer was accepted. If so, the method 1900 may proceed to block 1912. If the offer was not accepted, the method 1900 may end.

At 1930, if the user desires to have the product delivered to his current location, the server may determine the location of the e-vapor device. For example, the server may query a GPS unit of the device. At 1930, the server may cause the product to be delivered to the location of the device and may bill or charge the user for the product.

In view of the foregoing, and by way of additional example, disclosed are aspects of a method or methods for providing an e-vapor club, as may be performed by a server as described herein.

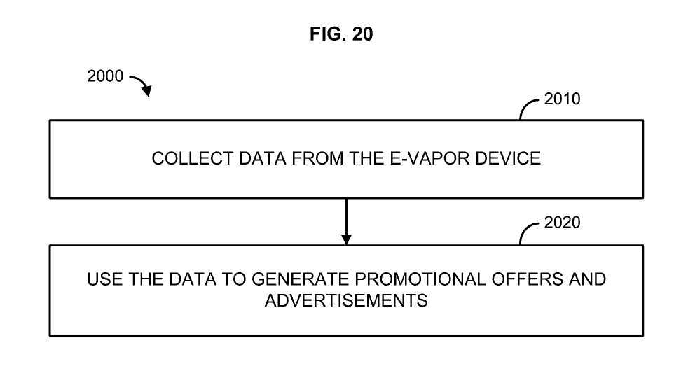

With reference now to FIG. 20, a method 2000 may include, at 2010, collecting data from the e-vapor device. For example, the data may include usage data or order history data. The data may also be collected from communications of the users of the e-vapor club. For example, the data may be mined from a message board of the e-vapor club.

In some embodiments, data from various devices may be collected and analyzed to determine patterns of the particular user and/or one or more groups. The analyzed data may be used, at 2020, to generate promotional offers and/or advertisements. For example, the user may be classified with a group of users of e-vapor devices. The analyzed data may indicate that users of this group are attracted to vanilla flavors, The server may advertise one or more vaporizable materials having a vanilla flavor to the user (and/or to other users of the group).

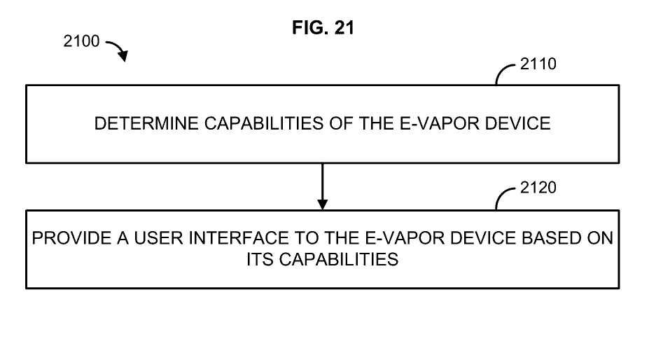

With reference now to FIG. 21, a method 2100 may include, at 2110, determining capabilities of the e-vapor device, For example, the capabilities may include processing capabilities, available input devices, available output devices, memory devices, and/or other capabilities of the device. In some embodiments, the e-vapor device may automatically transmit its capabilities to the server upon connection. In some embodiments, the server may query the device to determine its capabilities.

At 2120, the method 2100 may include providing a user interface to the e-vapor device based on the determined capabilities. For example, if a device has a display, the server may transmit a graphical user interface to the device; however, if the device doesn't include sufficient processing power for the GUI, the server may transmit an alternative user interface, such as text or audio based. Similarly, the available input devices can affect the types of input received from the device. For example, a device having a keyboard can provide more detailed input at a faster rate than a device having a single button. In some embodiments, the server may convert the received data into a desirable format and/or may request the processor of the device to convert the data into a desirable format prior to transmitting to the server.

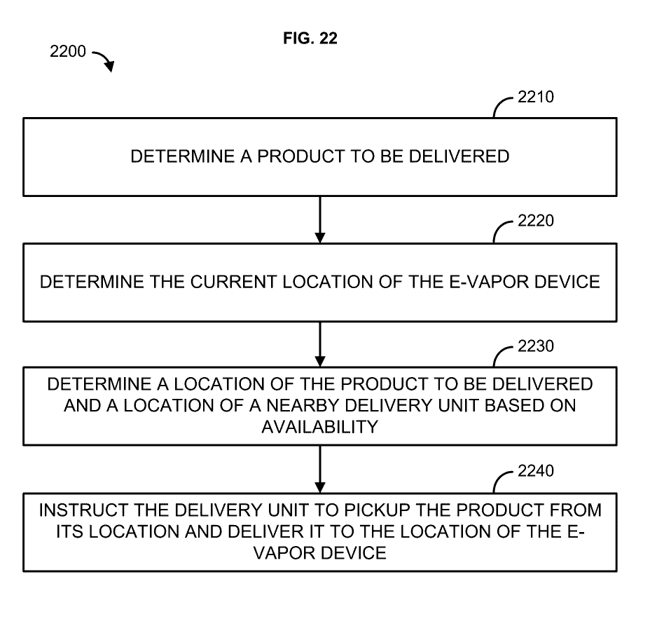

With reference now to FIG. 22, a method 2200 may include, at 2210, determining a product to be delivered to a user. For example, the product may be a product selected by the user for a one-time or periodic delivery. However, in some embodiments, the user may desire a new product at each period. The server may select the product based on analyzed data from the user's e-vapor device and/or other devices. In some embodiments, the product may be selected based on preferences of the user.

At 2220, the method 2200 may include determining the current location of the e-vapor device. For example, the e-vapor device may include a GPS for detecting location data, and a processor of the device may transmit the location data to the server using a network access device. In some embodiments, other sensors may be used to enhance and/or replace the GPS device, such as one or more accelerometers.

At 2230, the method 2200 may include determining a location of the product to be delivered and a location of a nearby deliver unit based on availability. For example, the server may use the location of the device to determine nearby vapor supply stores. The server may then query one or more of the vapor supply stores for the desired product and may determine one or more stores that include the product. The server may also determine a nearby deliver unit that is available to deliver the product at the requested time. For example, a dedicated delivery team may provide an online schedule of their routes. The server may find a delivery person who is nearby and has time to deliver the goods In some embodiments, the deliver unit may include an autonomous vehicle (i.e., a “drone.”) The server may determine a nearby drone that is available to deliver the product.

At 2240, the server may instruct the deliver unit to pickup the product from its location and deliver it to the location of the e-vapor device. For example, the server may transmit the location of the store that is on the most direct route from the delivery unit to the location of the device. The server may also or instead look for an available delivery unit that can pick up and deliver the product in the least amount of time and/or distance. The server may then instruct the selected delivery unit to obtain the product from the selected store and deliver it to the location of the e-vapor device.

In an aspect, a system for managing an e-vapor club is disclosed comprising a server having a network communication device for communicating with at least one electronic vapor device and a processor for providing an e-vapor club service usable by the at least one electronic vapor device. The at least one electronic vapor device can comprise a first electronic vapor device that includes at least one of an input device or an output device through which a user can interact with the e-vapor club. The processor can be further configured to instruct the first electronic vapor device to output data advertising the e-vapor club. The processor can be further configured to charge a member of the e-vapor club for and initiate a transfer of goods related to the first electronic vapor device at periodic intervals. The goods can comprise at least one of a new electronic vapor device, a battery, an atomizer, a replaceable coil, wick material, another component for the first electronic vapor device, an accessory for the first electronic vapor device, or a vaporizable material The processor can be further configured to receive data from the at least one remote device and to select the goods based on the received data. The data can comprise at least one of a user preference, observed user behavior, observed group behavior or research.

The at least one remote device can comprise a plurality of remote devices and wherein the processor is further configured to receive data from each of the plurality of remote devices that corresponds to preferences of users of each of the plurality of remote devices, and configured to select the goods based on the received data from each of the plurality of devices. Each of the plurality of remote devices can receive different goods based on the received data. The processor can be further configured to receive data from the at least one remote device indicating a specific good and the transfer of goods includes the specific good. The processor can be further configured to select a new good to transmit to a user of the electronic vapor device at each of the periodic intervals. The at least one remote device can comprise a first device associated with a first tier of e-vapor club members and a second device associated with a second tier of e-vapor club members and wherein the processor is further configured to charge for and initiate a transfer of the same type of good having different qualities to the first device and the second device. The at least one remote device can comprise a first device associated with a first service of the e-vapor club and a second device associated with a second service of the e-vapor club and wherein the processor is further configured to charge for and initiate a transfer of at least one of a different type of good or a different quantity of goods to the first device and to the second device. The at least one remote device can comprise a first device associated with a first service of the e-vapor club and a second device associated with a second service of the e-vapor club and wherein the periodic interval is different for the first device and the second device.

The processor can be further configured to at least one of receive a location of the electronic vapor device and initiate the transfer of goods to the location, initiate the transfer of goods to an address that is different than the location of the electronic vapor device, or to transmit a location of a retail store from which the goods can be received to the electronic vapor device, The processor can be further configured to receive a location of the vapor device and to transmit a location or name of at least one vaporizer supply store that is within a predetermined distance of the location of the at least one remote device to the at least one remote vapor device. The processor can be configured to transmit at least one of a one-time purchase offer, content, an offer to subscribe to a repeat subscription purchase package, a recommendation, an advertisement, advice or guidance. The system can further comprise a non-transitory memory and wherein the processor is further configured to store purchase patterns of a user of the electronic vapor device in the memory and to transmit the stored purchase patterns with another remote device. The processor can be further configured to determine whether the other remote device purchased an item listed in the stored purchase patterns of the user and, if so, to provide an incentive to the electronic vapor device. The electronic vapor device can comprise at least one of a monocle, an eCig, an e-vapor pipe, a hybrid phone, a vapor-bot, a micro e-vapor device, or another vapor device capable of at least one of transmitting or receiving data.

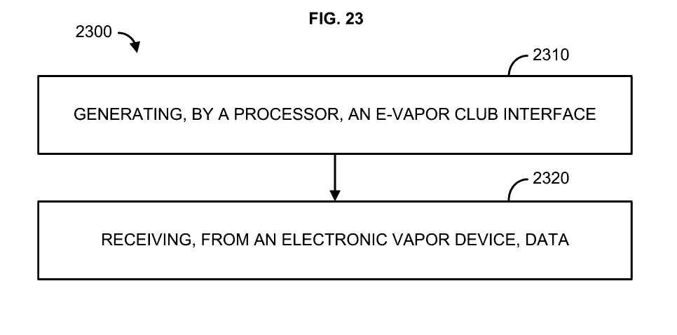

In an aspect, illustrated in FIG. 23, provided is a method 2300 for providing an e-vapor club by a server comprising generating, by a processor, an e-vapor club interface at 2310 and receiving, from an electronic vapor device, data at 2320. The method 2300 can further comprise at least one of receiving, from an input of the electronic vapor device, an input or transmitting, to an output of the electronic vapor device, an output. The method 2300 can further comprise transmitting, to the electronic vapor device, data to be output, the data including an advertisement of the e-vapor club. The method 2300 can further comprise charging, by the processor, a user of the electronic vapor device for a good at a periodic interval and initiating, by the processor, a transfer of the good to the user at the periodic interval.

The good can comprise at least one of a new electronic vapor device, a battery, an atomizer, a replaceable coil, wick material, another component for the electronic vapor device, an accessory for the electronic vapor device, or a vaporizable material. The method 2300 can further comprise selecting, by the processor, the good based on the data. The data can comprise at least one of a user preference, an observed behavior, observed group behavior or research. The method 2300 can further comprise receiving, from a second electronic vapor device, second data and selecting, by the processor, the good based on the data received from the first electronic vapor device and the second data received from the second electronic vapor device.

A user of the first electronic vapor device can receive a different good than a user of the electronic vapor device. The data can indicate a specific good requested by a user and the good can comprise the specific good. The method 2300 can further comprise selecting, by the processor, a new good at each periodic interval. The method 2300 can further comprise receiving, from a second electronic vapor device, second data, charging, by the processor, a second user of the second electronic vapor device for a second good at a second periodic interval, and initiating, by the processor, a transfer of the second good to the second user at the second periodic interval.

The first electronic vapor device and the second electronic vapor device can be each associated with a different tier of e-vapor club members, and wherein the second good can be the same type of good as the first good has different qualities than the first good. The first electronic vapor device can be associated with a first service and the second electronic vapor device can be associated with a second service, and wherein the second good is a different type of good than the first good. The first periodic interval can be different than the second periodic interval.

The method 2300 can further comprise at least one of receiving, by the processor, a location of the electronic vapor device and initiate the transfer of goods to the location, initiating, by the processor, the transfer of goods to an address that is different than the location of the electronic vapor device, or transmitting, by the processor, a location of a retail store from which the goods can be received to the electronic vapor device.

The method 2300 can further comprise transmitting, by the processor, a location or name of at least one vaporizer supply store that is within a predetermined distance of a location of the electronic vapor device, and wherein the data includes the location of the electronic vapor device. The data can comprise at least one of a one-time purchase offer, content, an offer to subscribe to a repeat subscription purchase package, a recommendation, an advertisement, advice or guidance.

The method 2300 can further comprise receiving, by the processor, the data that includes purchase patterns of a user of the electronic vapor device, storing, in a memory, the purchase patterns of the user, and transmitting, by the processor, the stored purchase patterns to a second remote device. The method 2300 can further comprise receiving, by the processor, an order request of a second good from the second remote device, determining, by the processor, whether the second good is found in the transmitted purchase patterns, and transmitting, by the processor, an offer for an incentive to the first electronic vapor device if the second good is found in the transmitted purchase patterns.

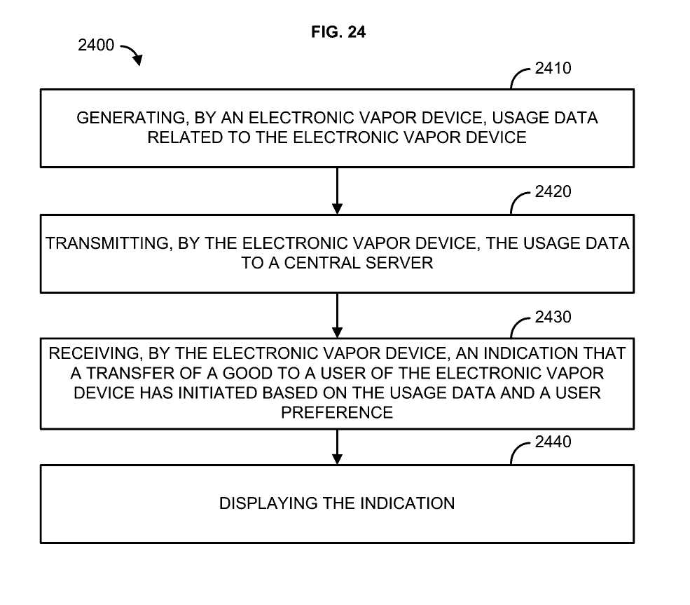

In an aspect, illustrated in FIG. 24, a method 2400 is disclosed comprising generating, by an electronic vapor device, usage data related to the electronic vapor device at 2410, transmitting, by the electronic vapor device, the usage data to a central server at 2420, receiving, by the electronic vapor device, an indication that a transfer of a good to a user of the electronic vapor device has initiated based on the usage data and a user preference at 2430, and displaying the indication at 2440.

Generating, by the electronic vapor device, usage data can comprise determining one or more of chronological usage, a type of vaporizable material used, a mixture of vaporizable material used, a frequency of usage, a duration of usage, a location of usage, a recommendation, a purpose for usage, an age of user, a sex of user, a race of user, a hobby of user, a type of electronic vapor device, a purchase pattern of a user of the electronic vapor device, a status of one or more components of the electronic vapor device. Transmitting the usage data to the central server can comprise one or more of cellular communication, Wi-Fi communication, Bluetooth® communication, and satellite communication.

The user preference can comprise one or more of a tier of membership in an electronic vapor (eVapor) club, a time interval for periodic delivery of the good, a preferred retail location, a preferred delivery location. The indication can comprise an instruction to pick up the good from the preferred retail location. A quality of the good is based on the tier of membership in the eVapor club. The good can comprise one or more of a new electronic vapor device, a battery, an atomizer, a replaceable coil, a wick material, an accessory for the electronic vapor device, or a vaporizable material.

Receiving, by the electronic vapor device, an indication that a transfer of a good to a user of the electronic vapor device has initiated based on the usage data and a user preference occurs at a periodic interval. The good can be selected based on recommendation data. The recommendation data can comprise a recommendation for a vaporizable material that a user has not used, a recommendation for a vaporizable material that a user has used, a recommendation for a mixture of two or more vaporizable materials that a user has not used, a recommendation for a mixture of two or more vaporizable materials that a user has used, a recommendation for a brand, a recommendation for a sale, a recommendation for a retailer, a recommendation for a manufacturer, a recommendation for an event, a recommendation for a social network, or a combination thereof.

The method 2400 can further comprise providing, by the electronic vapor device, an interface configured to permit a user of the electronic vapor device to interact with the indication. The method 2400 can further comprise receiving a selection of at least a portion of the indication. Receiving the selection of the at least a portion of the indication can comprise receiving an interaction with one or more uniform resource locators (URLs).

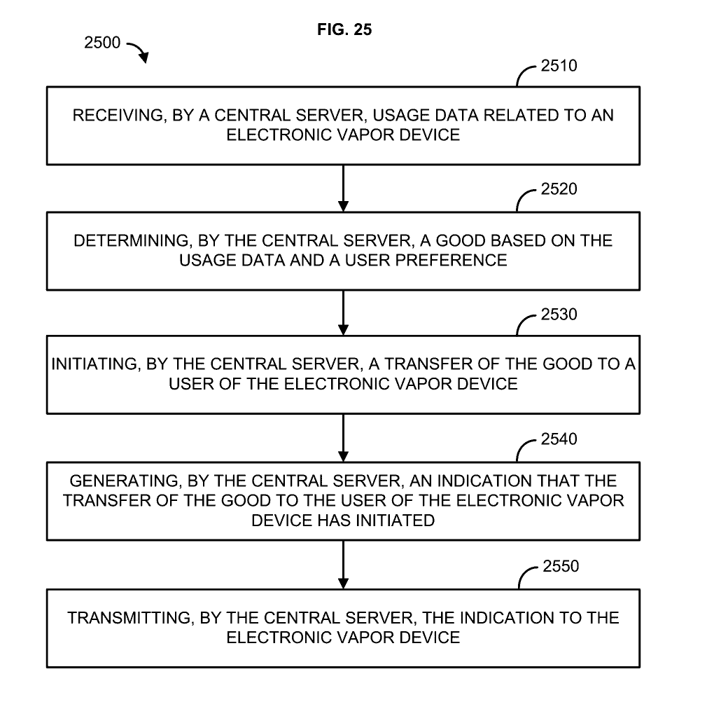

In an aspect, illustrated in FIG. 25, a method 2500 is disclosed comprising receiving, by a central server, usage data related to an electronic vapor device at 2510, determining, by the central server, a good based on the usage data and a user preference at 2520, initiating, by the central server, a transfer of the good to a user of the electronic vapor device at 2530, generating, by the central server, an indication that the transfer of the good to the user of the electronic vapor device has initiated at 2540, and transmitting, by the central server, the indication to the electronic vapor device at 2550.

The usage data can comprise one or more of chronological usage, a type of vaporizable material used, a mixture of vaporizable material used, a frequency of usage, a duration of usage, a location of usage, a recommendation, a purpose for usage, an age of user, a sex of user, a race of user, a hobby of user, a type of electronic vapor device, a purchase pattern of a user of the electronic vapor device, a status of one or more components of the electronic vapor device. Receiving, by a central server, usage data related to an electronic vapor device can comprise one or more of cellular communication, Wi-Fi communication, Bluetooth® communication, and satellite communication.

The user preference can comprise one or more of a tier of membership in an electronic vapor (eVapor) club, a time interval for periodic delivery of the good, a preferred retail location, a preferred delivery location. The indication can comprise an instruction to pick up the good from the preferred retail location. A quality of the good is based on the tier of membership in the eVapor club. The good can comprise one or more of a new electronic vapor device, a battery, an atomizer, a replaceable coil, a wick material, an accessory for the electronic vapor device, or a vaporizable material.

The good can be selected based on recommendation data. The recommendation data can comprise a recommendation for a vaporizable material that a user has not used, a recommendation for a vaporizable material that a user has used, a recommendation for a mixture of two or more vaporizable materials that a user has not used, a recommendation for a mixture of two or more vaporizable materials that a user has used, a recommendation for a brand, a recommendation for a sale, a recommendation for a retailer, a recommendation for a manufacturer, a recommendation for an event, a recommendation for a social network, or a combination thereof.

The method 2500 can further comprise receiving, by the central server, an indication of whether the user liked or did not like the good. The method 2500 can further comprise updating the user preference based on the indication of whether the user liked or did not like the good.

In view of the exemplary systems described supra, methodologies that can be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks can be required to implement the methodologies described herein. Additionally, it should be further appreciated that the methodologies disclosed herein are capable of being stored on an article of manufacture to facilitate transporting and transferring such methodologies to computers.

Those of skill would further appreciate that the various illustrative logical blocks, modules, circuits, and algorithm steps described in connection with the aspects disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure,

As used in this application, the terms “component,” “module,” “system,” and the like are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component can be localized on one computer and/or distributed between two or more computers.

As used herein, a nebulizing device uses oxygen, compressed air or ultrasonic power to break up medical solutions and suspensions into small aerosol droplets that may be directly inhaled from a mouthpiece of the device. It may be electronic and battery powered as well known in the art. The definition of an “aerosol” as used herein is a “mixture of gas and liquid particles,” and the best example of a naturally occurring aerosol is mist, formed when small vaporized water particles mixed with hot ambient air are cooled down and condense into a fine cloud of visible airborne water droplets.

As used herein, a “vapor” includes mixtures of a carrier gas or gaseous mixture (for example, air) with any one or more of a dissolved gas, suspended solid particles, or suspended liquid droplets, wherein a substantial fraction of the particles or droplets if present are characterized by an average diameter of not greater than three microns. As used herein, an “aerosol” has the same meaning as “vapor,” except for requiring the presence of at least one of particles or droplets. A substantial fraction means 10% or greater; however, it should be appreciated that higher fractions of small (<3 micron) particles or droplets can be desirable, up to and including 100%. It should further be appreciated that, to simulate smoke, average particle or droplet size can be less than three microns, for example, can be less than one micron with particles or droplets distributed in the range of 0.01 to 1 micron. A vaporizer may include any device or assembly that produces a vapor or aerosol from a carrier gas or gaseous mixture and at least one vaporizable material. An aerosolizer is a species of vaporizer, and as such is included in the meaning of vaporizer as used herein, except where specifically disclaimed.

Various aspects presented in terms of systems can comprise a number of components, modules, and the like. It is to be understood and appreciated that the various systems may include additional components, modules, etc. and/or may not include all of the components, modules, etc. discussed in connection with the figures. A combination of these approaches can also be used.

In addition, the various illustrative logical blocks, modules, and circuits described in connection with certain aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein can be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor can read information from, and write information to, the storage medium. In the alternative, the storage medium can be integral to the processor. The processor and the storage medium may reside in an ASIC or may reside as discrete components in another device.

Furthermore, the one or more versions can be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Those skilled in the art will recognize many modifications can be made to this configuration without departing from the scope of the disclosed aspects.

The previous description of the disclosed aspects is provided to enable any person skilled in the art to make or use the present disclosure. Various modifications to these aspects will be readily apparent to those skilled in the art, and the generic principles defined herein can be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
generating, by an electronic vapor device, usage data related to the electronic vapor device;
transmitting, by the electronic vapor device, the usage data to a central server;
receiving, by the electronic vapor device, an indication that a transfer of a good to a user of the electronic vapor device has initiated based on the usage data and a user preference; and
displaying the indication.

2. The method of claim 1, wherein generating, by the electronic vapor device, usage data comprises determining one or more of chronological usage, a type of vaporizable material used, a mixture of vaporizable material used, a frequency of usage, a duration of usage, a location of usage, a recommendation, a purpose for usage, an age of user, a sex of user, a race of user, a hobby of user, a type of electronic vapor device, a purchase pattern of a user of the electronic vapor device, a status of one or more components of the electronic vapor device.

3. The method of claim 1, wherein transmitting the usage data to the central server comprises one or more of cellular communication, Wi-Fi communication, Bluetooth® communication, and satellite communication.

4. The method of claim 1, wherein the user preference comprises one or more of a tier of membership in an electronic vapor (eVapor) club, a time interval for periodic delivery of the good, a preferred retail location, a preferred delivery location.

5. The method of claim 4, wherein the indication comprises an instruction to pick up the good from the preferred retail location.

6. The method of claim 4, wherein a quality of the good is based on the tier of membership in the eVapor club.

7. The method of claim 1, wherein the good comprises one or more of a new electronic vapor device, a battery, an atomizer, a replaceable coil, a wick material, an accessory for the electronic vapor device, or a vaporizable material.

8. The method of claim 1, wherein receiving, by the electronic vapor device, an indication that a transfer of a good to a user of the electronic vapor device has initiated based on the usage data and a user preference occurs at a periodic interval.

9. The method of claim 1, wherein the good is selected based on recommendation data.

10. The method of claim 9, wherein the recommendation data comprises a recommendation for a vaporizable material that a user has not used, a recommendation for a vaporizable material that a user has used, a recommendation for a mixture of two or more vaporizable materials that a user has not used, a recommendation for a mixture of two or more vaporizable materials that a user has used, a recommendation for a brand, a recommendation for a sale, a recommendation for a retailer, a recommendation for a manufacturer, a recommendation for an event, a recommendation for a social network, or a combination thereof.

11. The method of claim 1, further comprising providing, by the electronic vapor device, an interface configured to permit a user of the electronic vapor device to interact with the indication.

12. The method of claim 1, further comprising receiving a selection of at least a portion of the indication.

13. The method of claim 11, wherein receiving the selection of the at least a portion of the indication comprises receiving an interaction with one or more uniform resource locators (URLs).

14. A method comprising:
receiving, by a central server, usage data related to an electronic vapor device;
determining, by the central server, a good based on the usage data and a user preference;
initiating, by the central server, a transfer of the good to a user of the electronic vapor device;
generating, by the central server, an indication that the transfer of the good to the user of the electronic vapor device has initiated; and
transmitting, by the central server, the indication to the electronic vapor device.

15. The method of claim 14, wherein the usage data comprises one or more of chronological usage, a type of vaporizable material used, a mixture of vaporizable material used, a frequency of usage, a duration of usage, a location of usage, a recommendation, a purpose for usage, an age of user, a sex of user, a race of user, a hobby of user, a type of electronic vapor device, a purchase pattern of a user of the electronic vapor device, a status of one or more components of the electronic vapor device.

16. The method of claim 14, wherein receiving, by a central server, usage data related to an electronic vapor device comprises one or more of cellular communication, Wi-Fi communication, Bluetooth® communication, and satellite communication.

17. The method of claim 14, wherein the user preference comprises one or more of a tier of membership in an electronic vapor (eVapor) club, a time interval for periodic delivery of the good, a preferred retail location, a preferred delivery location.

18. The method of claim 17, wherein the indication comprises an instruction to pick up the good from the preferred retail location.

19. The method of claim 17, wherein a quality of the good is based on the tier of membership in the eVapor club.

20. The method of claim 14, wherein the good comprises one or more of a new electronic vapor device, a battery, an atomizer, a replaceable coil, a wick material, an accessory for the electronic vapor device, or a vaporizable material.
